(19) United States
(12) Patent Application Publication
(10) Pub. No.: US 2026/0027663 A1
(43) Pub. Date: Jan. 29, 2026

(54) SELECTIVELY CONFIGURABLE TUBE-HOLDING APPARATUS FOR USE IN TUBE-WELDING SYSTEM

(71) Applicant: Re:Build Manufacturing, LLC, Framingham, MA (US)

(72) Inventors: Nicholas Lauder, Medford, MA (US); Nathan Typrowicz-Cohen, Arlington, MA (US); Katherine Henshaw, Cambridge, MA (US); Kenneth A. Ritsher, Lowell, MA (US); Marco Arosemena, Boston, MA (US)

(21) Appl. No.: 19/283,452

(22) Filed: Jul. 29, 2025

Related U.S. Application Data
(60) Provisional application No. 63/676,604, filed on Jul. 29, 2024.

(51) Int. Cl. B23K 37/04

(52) U.S. Cl. CPC B23K 37/0452

(57) ABSTRACT

A selectively configurable tube-holding apparatus for use in tube-welding system by a frame, defining a recess and a pinching surface; a selector wheel, disposed in the recess and defining first and second pairs of tube holding divots; wherein: the selector wheel is rotatably connected to the frame, each divot of the first pair is of a first gauge different from a second gauge for each divot of the second pair, the selector wheel is rotatable to first and second positions; in the first position, radial centers of the first pair are aligned to be in the parallel plane with the pinching surface the second pair are not, and in the second position, the radial centers of the second pair are aligned to be in the parallel plane with the pinching surface and the radial centers of the first pair are not.

The present disclosure claims priority to U.S. Provisional Patent Application 63/676,604, filed on 2024 Jul. 29, titled “SELECTIVELY CONFIGURABLE TUBE-HOLDING APPARATUS FOR USE IN TUBE-WELDING SYSTEM”, which is incorporated herein in its entirety.

### BACKGROUND

Tube-welding systems are designed to join two lengths of plastic tubing to one another, and are frequently used in medical settings as well as in laboratory and bioprocessing settings. For example, in the medical field, tube-welding systems may be used to join tubing for containers of various products (such as plasma, blood, saline, therapeutic agents, etc.) to other tubes (such as different containers of plasma, blood, saline, therapeutic agents, etc.; or catheters or access ports connected to a patient). The systems generally operate by securing the tubes to be welded, cutting the tubes, melting the tube ends, aligning the tube ends to be welded together, and allowing the tubes to cool to form a fluid path between joined ends. Tube welding is an important process in a variety of biological application because tube welding can make sterile connections between otherwise closed volumes allowing cell, buffer, growth media or other materials to be introduced into a new environment like a cellular incubator, centrifuge, filter or analyzer.

A conventional tube welding system connects two tubes after cutting the tubes with a heated element that sterilizes the cut surfaces before the tubes are connected. Because the tubes are pressed flat during the process, liquid is forced out of the area of the weld. The connected tubes remain flat after the weld and the lumens of the tubes are not connected until a user squeezes the tubes to allow the tubes to return to an initially round shape and by breaking a small segment of melted tubing that is created during the weld and holds the tube flat after the welding process has completed.

### SUMMARY

The present disclosure provides a selectively configurable tube-holding apparatus for use in tube-welding system. The provided system offers greater flexibility of use cases, improved user safety, reduced maintenance and set-up requirements, over conventional tube-welding systems, among other benefits.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

FIGS. 1A-1D illustrate an example tube-welding system, according to embodiments of the present disclosure.

FIG. 2 illustrates an example tube-welding system in which a pair of tubes to be welded are captured, according to embodiments of the present disclosure.

FIGS. 3A and 3B illustrate an example holder for use with a tube-welding system in various rotational states, according to embodiments of the present disclosure.

FIGS. 4A-4C illustrate examples of clamping of tubes of differing thicknesses via an example holder, according to embodiments of the present disclosure.

FIGS. 5A-5C illustrate cut-away views of a tube being clamped by an example tube-welding system, according to embodiments of the present disclosure.

FIGS. 6A-6E illustrate spacing in the construction of tube-holding divots defined in the wheel of an example holder, according to embodiments of the present disclosure.

FIGS. 7A-7E illustrate the relative positions of various tubing and the cutting-welding means of the present disclosure during various operations for tube welding, according to embodiments of the present disclosure.

FIGS. 8A-8D illustrate various states of an example tube-welding system with respect to a platform and cassette, according to embodiments of the present disclosure.

FIGS. 9A-9D illustrate various examples of cassettes for use in an example tube-welding system, according to embodiments of the present disclosure.

FIG. 10 is a flowchart of an example method of operation of a tube-welding system, according to embodiments of the present disclosure.

FIG. 11 is a flowchart of an example method for replacing a cassette for a tube-welding system, according to embodiments of the present disclosure.

FIG. 12 is a flowchart of an example method of operation of a tube-welding system, according to embodiments of the present disclosure.

FIG. 13 illustrates a computing device, according to embodiments of the present disclosure.

### DETAILED DESCRIPTION

The present disclosure provides a selectively configurable tube-holding apparatus for use in tube-welding system. The provided system offers greater flexibility of use cases, improved user safety, reduced maintenance and set-up requirements, over conventional tube-welding systems, among other benefits.

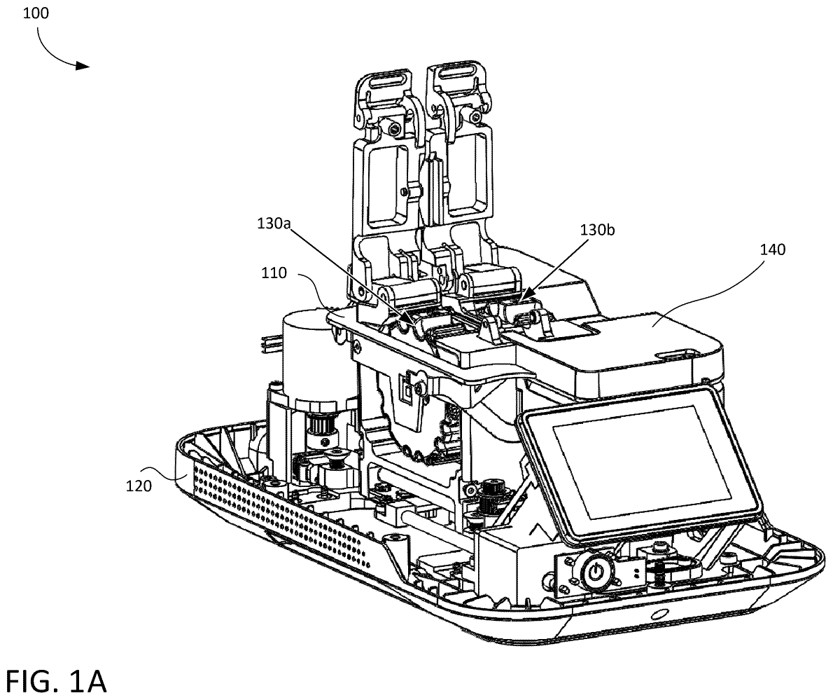

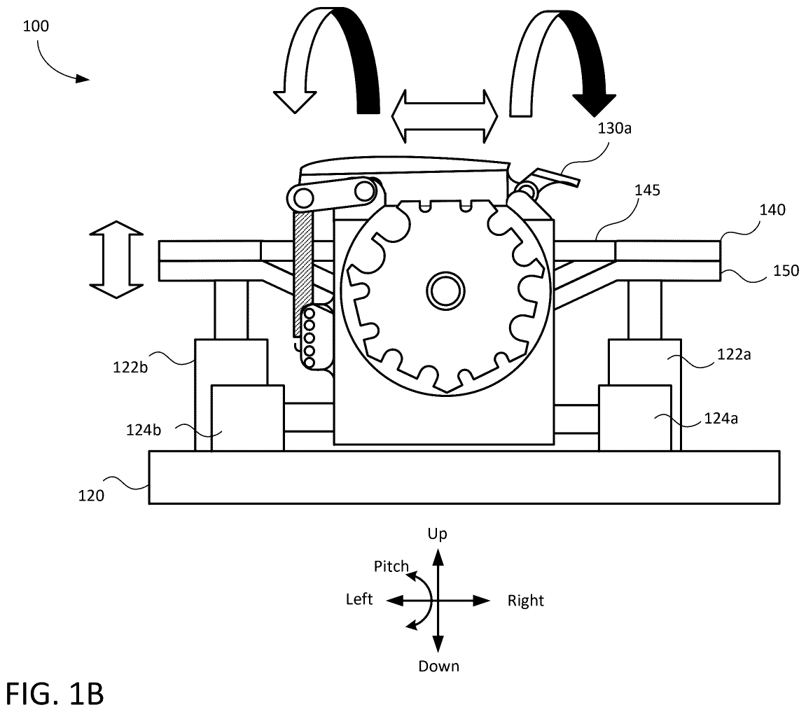

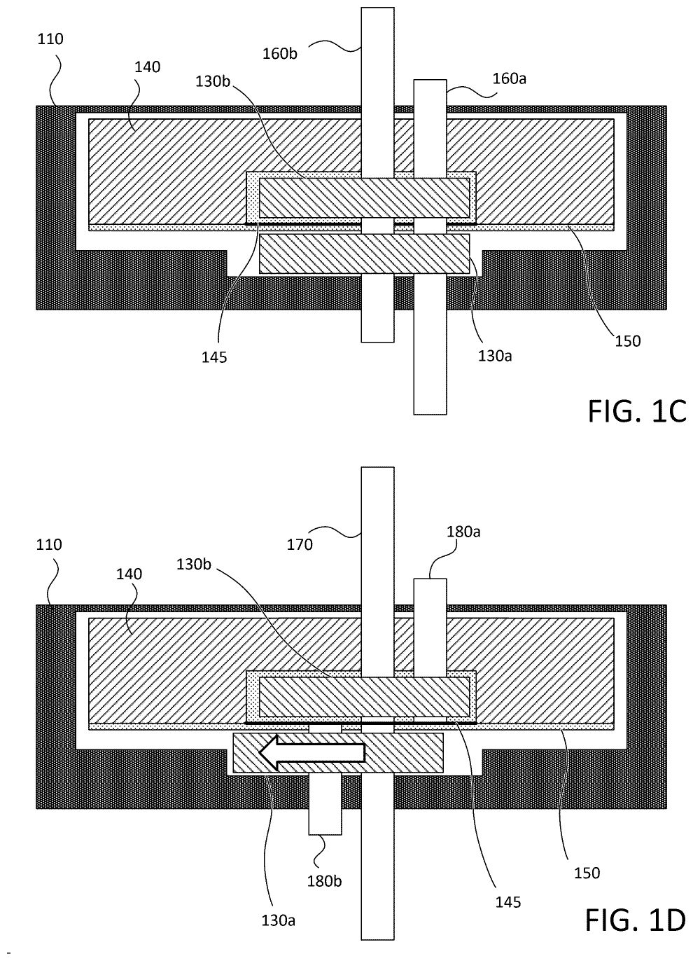

FIGS. 1A-1D illustrate an example tube-welding system 100, according to embodiments of the present disclosure. FIG. 1A illustrates an isometric view of the example tube-welding system 100, as a user may see the example tube-welding system 100, and FIG. 1B illustrates a side view to highlight moving parts within the example tube-welding system 100. FIGS. 1C and 1D illustrate relative positions of the moving parts of the tube-welding system 100 during cutting and welding operations.

A working surface 110 defines a cut-out in which various components of the tube-welding system 100 are housed during operation of the tube-welding system 100 and on which sections of tubing may be rested. Some of the components of the tube-welding system 100 may be affixed to a base 120. Although not illustrated in FIGS. 1A-1D, a casing may be defined around the working surface 110 and the base 120 to protect the internal mechanisms of the tube-welding system 100.

A first holder 130a (generally or collectively, holder 130) and a second holder 130b are connected to the base 120 and partially exposed through the working surface 110 so that a first tube 160a and a second tube 160b (generally or collectively, tube 160 or tubing 160) may be held and clamped in the holders 130 during cutting and welding operations. As shown in FIGS. 1C and 1D, the first holder 130a and the second holder 130b are initially aligned such that the first tube 160a and the second tube 160b are parallel to one another, but the first holder 130a shifts to one side after the tubes 160 are cut so that a portion of the first tube 160a is aligned with a portion of the second tube 160b so that those portions may be welded together to produce a joined tube 170. The remaining sections of the first tube 160a and the second tube 160b not part of the joined tube 170 may also be welded shut from sections of the first tube 160a and the second tube 160b, and may be referred to as a first closed tubing 180a (generally or collectively, closed tubing 180) and a second closed tubing 180b, which may be discarded as waste in some embodiments.

The first holder 130a and the second holder 130b are spaced apart from one another to allow a cutting-welding means 145 to be positioned between the holders 130 and raised and lowered when cutting and welding the tubes 160. The cutting-welding means 145 is provided from the cassette 140, and provides a cutting edge to sever the tubes 160 when raised from a first position to a second position. The cutting-welding means 145 also provides a heating surface to transfer heat the cut ends of the tubes 160 so that the ends weld together when the cutting-welding means 145 is removed from between the tubes 160 and the tubes 160 are allowed to cool.

The cassette 140 is selectively secured with a platform 150 that provides various electrical connections and other devices for interaction with the cassette 140. The platform 150 operates in conjunction with one or more vertical movement means 122a-b (generally or collectively, vertical movement means 122) or lift elements of the base 120 that raise and lower the platform 150 relative to the base 120, and in turn, position the cutting-welding means 145 of an attached cassette 140 at different heights relative to the tubing 160 held in the holders 130 to thereby cut and weld such tubing 160. Additionally, the platform 150 controls the vertical position of the cassette 140 (when secured) relative to the base 120 and working surface 110 to reduce the risk of a user accidentally coming into contact with the cutting-welding means 145 and being inadvertently cut or burned. In various embodiments, the vertical movement means 122 may include pneumatically or hydraulically actuated pistons, cam assemblies, electrical motor and screw assemblies, or electrical motor and track assemblies.

In various embodiments, the cutting-welding means 145 may be a metallic ribbon that is spooled across opposing ends of the cassette 140. In some embodiments, the ribbon is a length of metal that has a height dimension greater than a thickness dimension. In various embodiments, the height dimension is configured relative to the wall thickness of the tubes 160 that the ribbon is intended to cut (e.g., at least twice the wall thickness of the tubes 160, defined between an inner and outer diameter thereof). For example, a ribbon configured to cutting and welding tubes 160 having a wall thickness of 1/16 of an inch may be at least ⅛ of an inch in height, while a ribbon configured to cutting and welding tubes 160 having a wall thickness of 1/32 of an inch may be at least 1/16 of an inch in height. For example, a ribbon configured to cutting and welding tubes 160 having a wall thickness of 1.5 mm may be at least 3 mm in height, while a ribbon configured to cutting and welding tubes 160 having a wall thickness of 0.75 mm may be at least 1.5 mm in height.

In various embodiments, the ribbon is heated according to the melting temperature of the material used in the tubes 160 to be cut, and may cut based on the melting action (e.g., burning or melting through any interposing material), via physical properties of the ribbon (e.g., a cutting or bladed surface), and combinations thereof. In various embodiments, the ribbon is heated to at least 400 degrees Celsius (° C.) to depyrogenate the ribbon prior to cutting/welding to destroy or remove any proteins, oils, or residues on the surfaces of the ribbon.

In various embodiments, the ribbon may be cooled from a depyrogenation temperature to a cutting temperature based on a melting temperature of a material used in the tubes 160 or other elements to be cut, which may be between 150-500° C. For example, the ribbon may be raised to a deprogenation temperature of approximately 400° C. and lowered to a cut-and-weld temperature of approximately 350° C. However, the cut-and-weld temperature may be lowered for one or more of the cutting/welding operations based on the material used in the tubes 160 and melting temperatures thereof (e.g., about 260° C. for polyvinylchloride (PVC) or about 170° C. for C-Flex, Advantaflex, PharMed, and SaniPure (all trademarks reserved for their respective holders)).

In some embodiments, the ribbon is unsharpened or includes a straight cutting edge on an upper surface with a single bevel grind (facing a single holder 130) or a dual bevel grind (facing both of the holders 130). In some embodiments, the cutting-welding means 145 is a metallic saw-tooth ribbon with a serrated cutting edge on an upper surface with various cutting edges and tooth configurations, known to those of skill in the art. In some embodiments, the cutting-welding means 145 is one or more wires arranged in a sequence (e.g., vertically stacked). Embodiments that use a metallic ribbon structure offer greater structural rigidity in the cutting direction than wires, while offering a broad surface for uniform heat transfer to weld the tubes 160. Additionally, the greater amount of material used in the ribbon reduces the risk of temperature loss to the tubing 160 during cutting operations—maintaining a more constant temperate as the cutting-welding means 145 comes into contact with the tubes 160 than a similar wire would.

In addition to cutting the tubes 160, the cutting-welding means 145 is configured to transfer heat to the tubes 160 so that the tubes 160 may be welded together (e.g., the joined tube 170) or welded shut (e.g., the closed tubing 180). Accordingly, the cutting-welding means 145 may be made of various metals or alloys operable as a resistance heating element that can be heated by passing an electrical current therethrough. Some examples of materials for the cutting-welding means 145, which are selected for resistive-heating properties, the (optional) ability to hold a sharpened edge even when heated, and to form coiled sheets (e.g., ribbons) include various nichrome alloys (e.g., Nickel (Ni) and Chromium (Cr) in ratios of 80/60/35 wt % Ni to 20/16/20 wt % Cr, respectively, with a remainder being Iron (Fe) and trace elements), various steel alloys, various bronze alloys, and the like.

The side-to-side motion of the first holder 130a relative to the second holder 130b may be achieved by various horizontal movement means 124a-b (generally or collectively, horizontal movements means 124) of the base 120, such as pneumatically or hydraulically actuated pistons, or electrical motor and track assemblies. In embodiments using a serrated cutting-welding means 145, the system 100 may include a reciprocating means to move either the tubes 160 left-to-right relative to a static (in the left-to-right direction) cutting-welding means 145, such as additional horizontal movement means 124 associated with the second holder 130b or the platform 150. Additionally or alternatively, the cassette 140 may provide the reciprocating means by alternatingly spooling the cutting-welding means 145 between a first side and a second side of the cassette 140. Additionally or alternatively, the platform 150 may include a horizontal movement means that moves the cassette 140 and included cutting-welding means 145 back and forth to aid in cutting the tubing 160. In various embodiments, the horizontal movement means 124 may include pneumatically or hydraulically actuated pistons, cam assemblies, electrical motor and screw assemblies, or electrical motor and track assemblies.

In some embodiments, the base 120 includes separation adjustment means that are configured to move one or more of the holders 130 in a forward-backward direction to move the holders 130 closer or further from one another. Minor movement (e.g., 1-5 millimeters) may be imparted during the welding portion of the cutting-welding operations by the separation adjustment means to pull tubing 160 away from the cutting-welding means 145 (e.g., to avoid melting the tubing 160 to the heating surface of the cutting-welding means 145 or to use radiant heating rather than conductive heating to melt the cut ends of the tubing 160). Similarly, the separation adjustment means may move the holders 130 closer to one another to press the cut ends of the tubing together when forming a weld.

In some embodiments, the base 120 includes separation adjustment means that are configured to move one or more of the holders 130 in a pitching direction relative to the left-to-right direction to move at least portions of the holders 130 closer or further from one another. Minor movement (e.g., 1-5 millimeters) may be imparted during the welding portion of the cutting-welding operations by the separation adjustment means to pull tubing 160 away from the cutting-welding means 145 (e.g., to avoid melting the tubing 160 to the heating surface of the cutting-welding means 145 or to use radiant heating rather than conductive heating to melt the cut ends of the tubing 160). Similarly, the separation adjustment means may move the holders 130 closer to one another to press the cut ends of the tubing together when forming a weld.

In various embodiments, the various movement means may be configured for movement in in single axis or rotational direction, or for movement simultaneously in two or more directions and rotational directions. For example, a movement means may both move a holder 130 left-to-right and pitch the holder 130 forwards/backwards as part of a movement profile. In some embodiments, a movement means may move more than one element of the systems, such as moving both holders 130a-b at the same time, or moving the platform 150 and the holders 130a-b.

Although the figures show rotational movement of the holders 130 in a pitching degree of freedom, the present disclosure also contemplates yaw and rolling motion in the holders 130.

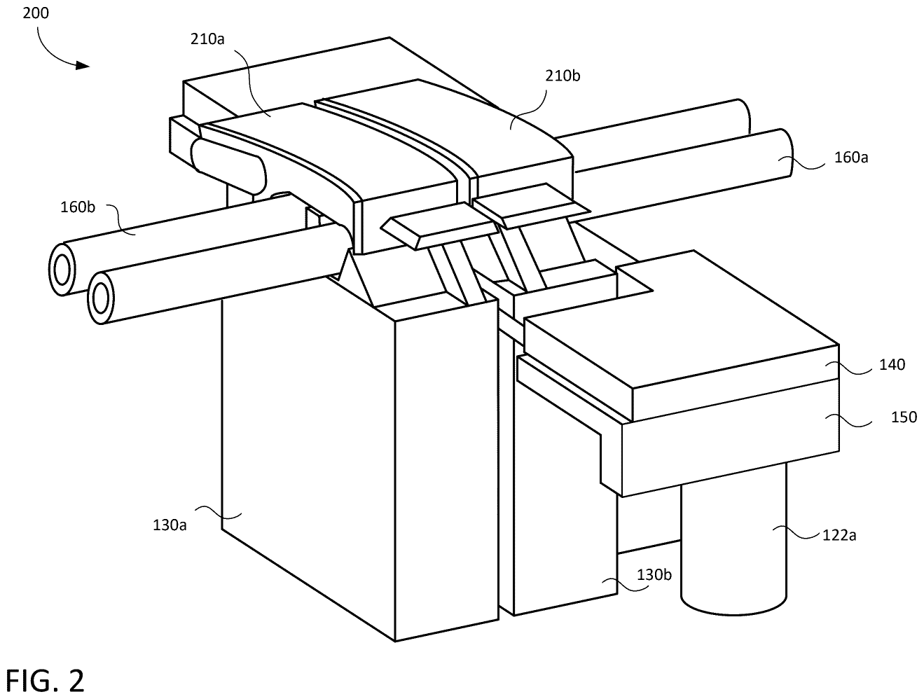

FIG. 2 illustrates a section 200 of an example tube-welding system 100 in which a pair of tubes 160a-b to be welded are captured, according to embodiments of the present disclosure. The platform 150 and main body of the cassette 140 are formed to conform around three sides of the second holder 130b and position the cutting-welding means between the two holders 130a-b on the side of the second holder 130b that the cassette 140 does not otherwise surround. The tubes 160 are held in place in the holders 130a-b via respective clamps 210a-b (generally or collectively, clamps 210) such that the tubes 160 are held over the gap between the holders 130 to permit the cutting-welding means 145 to cut through the tubes 160 at a consistent location.

Although illustrated with clamps 210 defined with rotational connections on the same side of the section 200, in various embodiments, the clamps 210 may instead be on the same side of the holders 130. Accordingly, the holders 130 may be identical to each other, but are rotated (e.g., about the height axis of the holders 130) relative to one another, resulting in the clamps 210 having rotational connections to different sides of the section 200, but the “same” side of each holder 130.

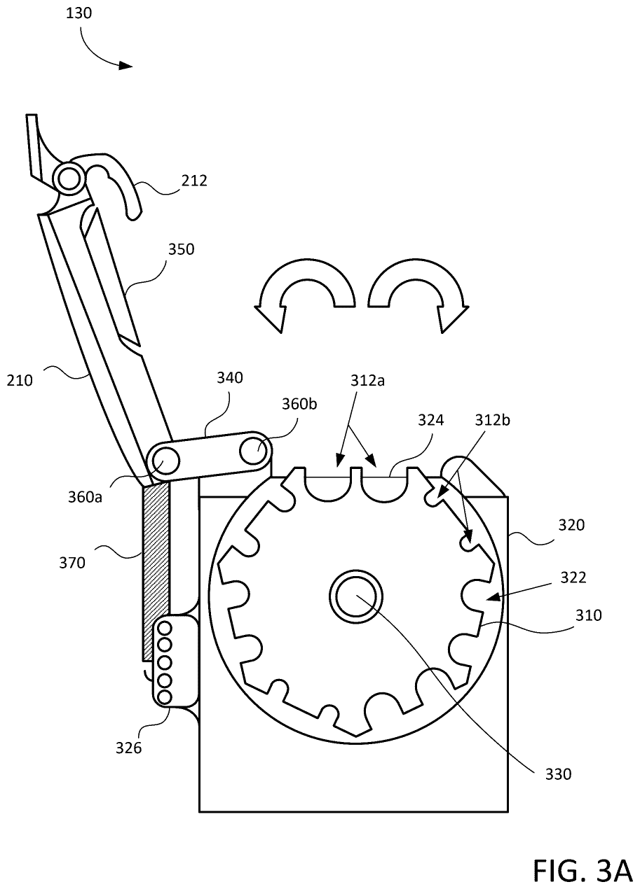

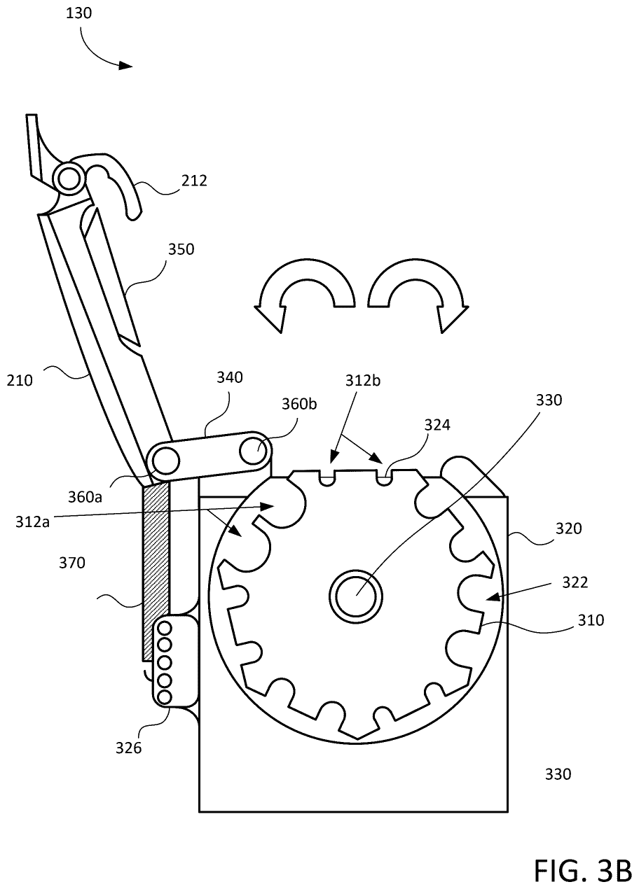

FIGS. 3A and 3B illustrate an example holder 130 for use with a tube-welding system 100 in various rotational states, according to embodiments of the present disclosure. The holder 130 includes a selector wheel 310 that is captured in a recess 322 of a frame 320 of the holder 130. An axle 330 or a rotational member of the selector wheel 310 acting as an axle 330 secures the selector wheel 310 to the frame 320 and defines a rotational axis about which the selector wheel 310 may be rotated relative to the frame 320. In various embodiments, the recess 322 and the selector wheel 310 may be exposed, as illustrated in FIGS. 3A-3B, or may be covered (e.g., by a faceplate over the recess 322).

In the embodiment illustrated in FIGS. 3A and 3B, the selector wheel 310 has a face that is rotationally centered on the axle 330, and includes a plurality of paired tube-holding divots 312 (individually, paired divots or pair of divots 312a, 312b, etc.) defined on an edge thereof that are each configured to hold a different gauge of tubing 160 therein. Each of the divots is a tube holding means for an individual tube 160, and the sets of such paired tube holding means give the selector wheel 310 the ability to interact with various tubes of differing gauges in a single system without having to rely on adapters or substituting parts. Although illustrated with a face having the shape of a regular polygon with seven sides, the present disclosure contemplates that the wheel face may be various regular or irregular polygons in shape, having a pair of divots 312 defined on each side thereof. Each pair of divots 312 are sized to accept tubing 160 of differing outer diameters, and to hold the tubing 160 in place relative to a pinching surface 324 of the frame 320. An operator may rotate the selector wheel 310 to orient different pairs of divots 312 with the pinching surface. For example, FIG. 3A shows a first pair of divots 312a aligned with the pinching surface 324 to hold tubing 160 of a first diameter in place, while FIG. 3B shows a second pair of divots 312b aligned with the pinching surface 324 to hold tubing 160 of a second diameter (different from the first diameter) in place.

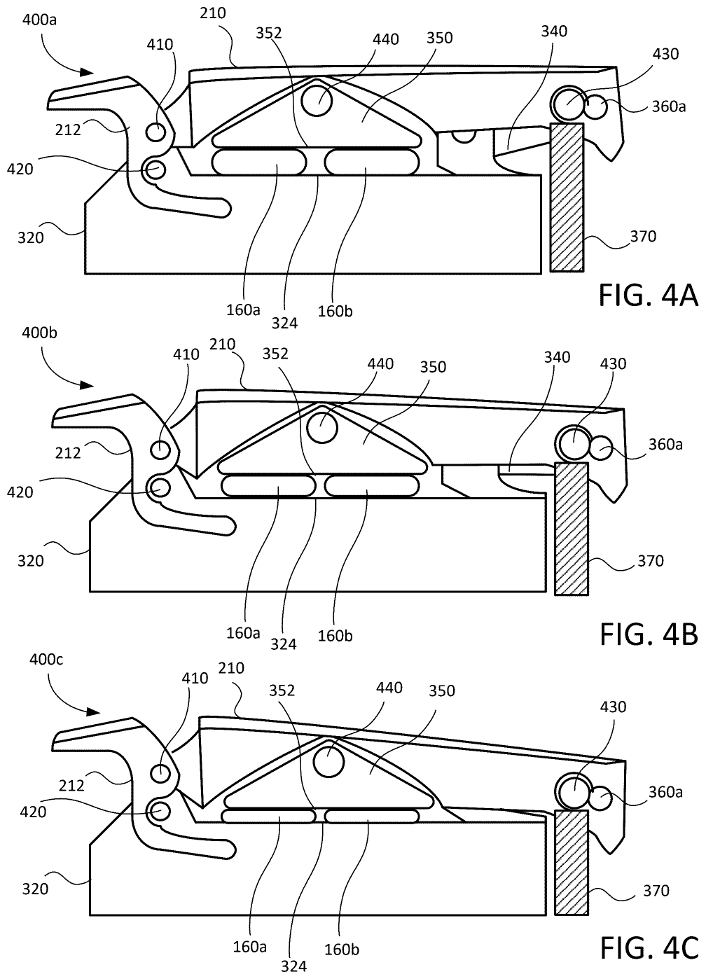

A first side of the clamp 210 is connected on a first side of the frame 320 via a linkage 340, that has a first rotational point 360a one a first end connected to the clamp 210 and a second rotational point 360b on a second end connected to the frame 320. The clamp 210 includes one a second end (opposite to the first end) a clasp 212 that is configured to hold the clamp 210 in place relative to the frame 320 (e.g., via a peg 420, shown in FIGS. 4A-4C). A bobbin 350 is located between the first end and the second end of the clamp 210, which serves and an opposing surface to the pinching surface 324 of the frame 320.

The end of the clamp 210 connected to the linkage 340 may also include a spring 370, connected on a first end to the clamp 210, and on a second end to a spring mount 326 of the frame 320. The spring 370 exerts a downward force on the first end of the clamp 210, and may be adjusted to connect to the spring mount 326 at different heights to vary the force exerted by the spring 370.

FIGS. 4A-4C illustrate examples 400a-c of clamping of tubes 160 of differing thicknesses via an example holder 130, according to embodiments of the present disclosure. The different thicknesses may be the result of selecting tubes 160 of differing outer diameters, selecting tubes 160 of the same outer diameter and different inner diameter, or selecting tubes of differing outer and inner diameters.

Each of the examples 400a-c in FIGS. 4A-4C show an opposing side of the holder 130 to the side shown in FIGS. 3A-3B, with the pinching surface 324 of the frame 320 in the foreground, rather than the background. The clasp 212 is secured via a peg 420 to the frame 320, and the clamp 210 is permitted to rotate the clasp 212 into and out of contact with the peg 420 via a first rotational point 410 (e.g., a pin rotatable connecting the clasp 212 with the end of the clamp 210.).

The spring 370 is connected on the other side of the clamp 210 relative to the clasp 212 via a connection point 430 (e.g., a pin or dowel in the clamp 210). In various embodiments, the spring 370 ends with a hook, that is secured around the connection point 430, which permits the spring 370 to maintain a downward pulling force on the clamp 210 regardless of the orientation of the clamp 210 relative to the frame 320.

Because the angle at which the clamp 210 engages with the tubes 160 changes based on the thickness of the tubes 160, the bobbin 350 is connected to the clamp 210 via an axle 440 that permits the bobbin 350 to rotate based on gravity. The mass of the bobbin 350 is evenly spread in the horizonal direction and vertical offset from the axle 440 so that the pinching surface 352 of the bobbin 350 (e.g., a second pinching surface) remains parallel to the pinching surface 324 of the frame 320 (e.g., a first pinching surface) as tubes 160 of differing diameters and wall thicknesses are held by the holder 130. In various embodiments, the axle 440 may be an extension of the clamping bobbin 350 or a separate component.

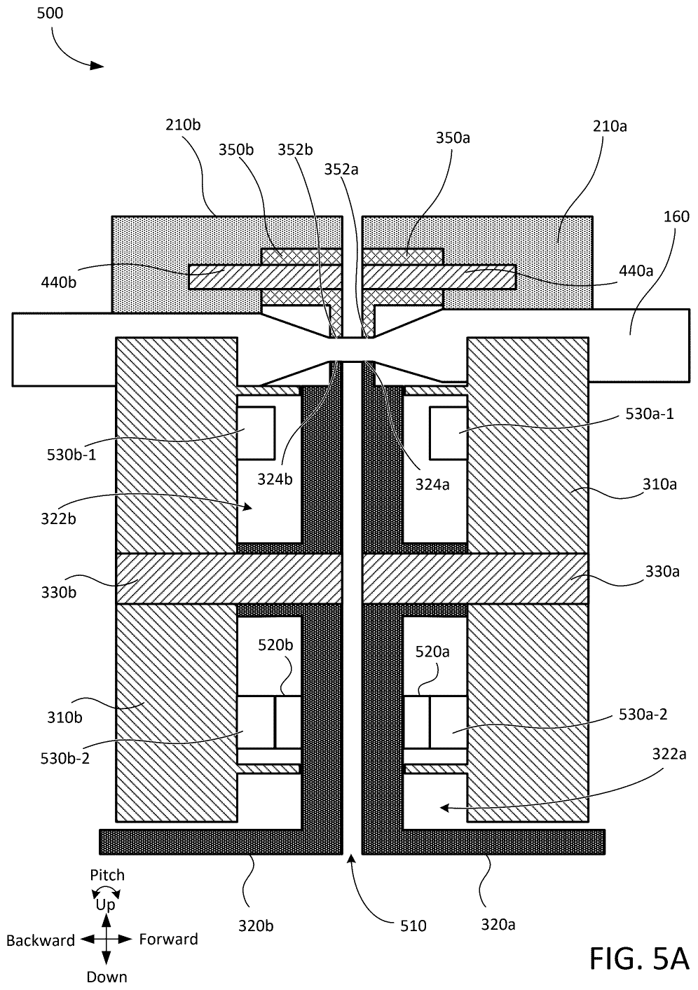

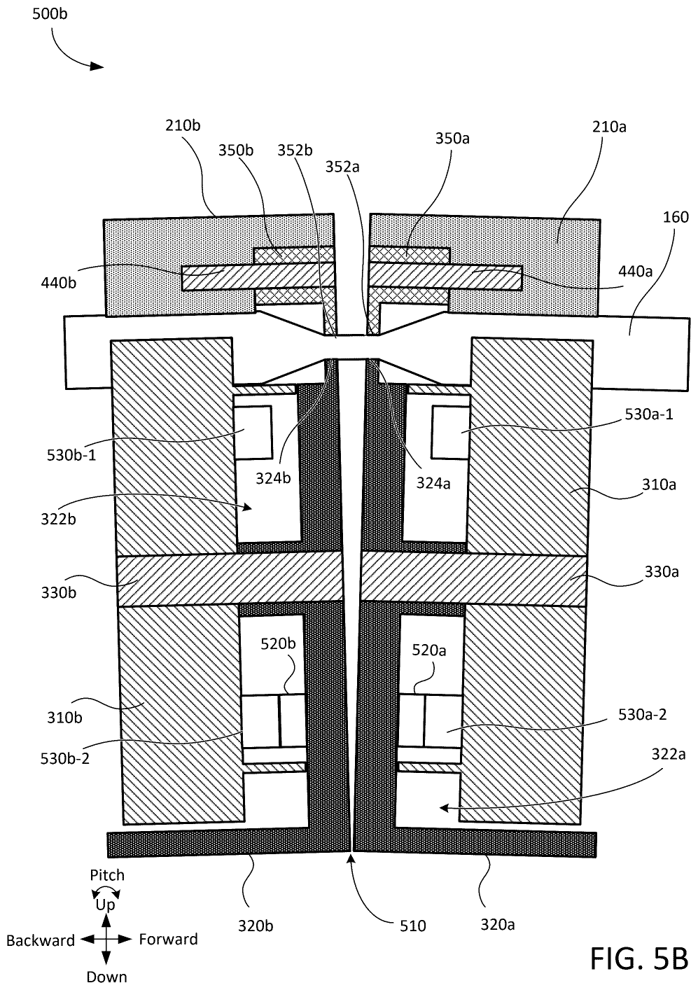

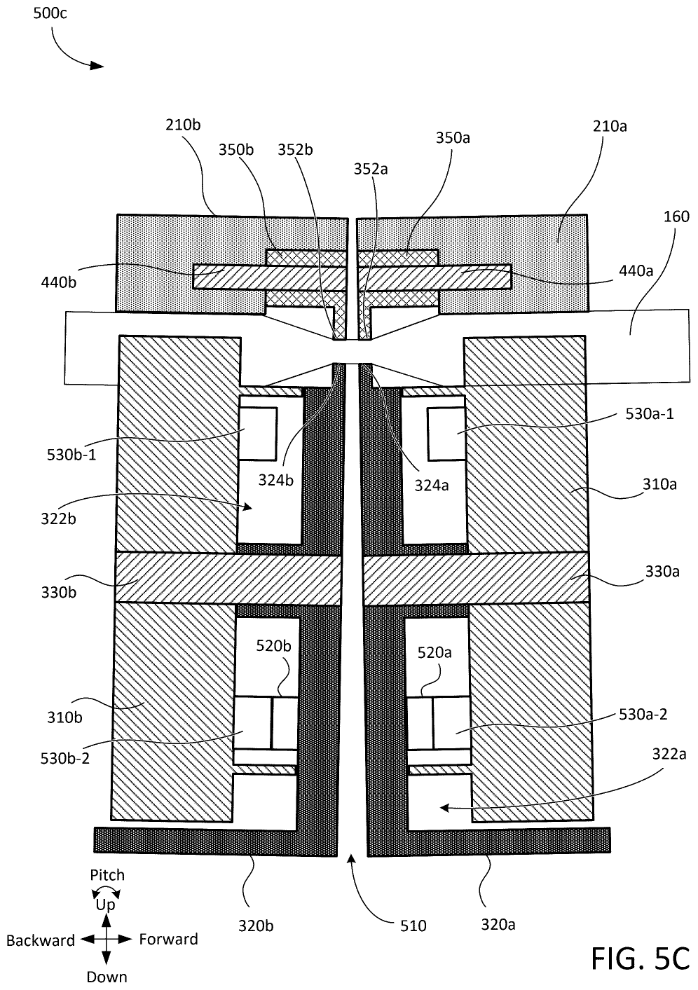

FIGS. 5A-5C illustrate cut-away views 500a-c of a tube 160 being clamped by an example tube-welding system 100, according to embodiments of the present disclosure. As illustrated, a first holder 130a holds a first end of the tube 160, and a second holder 130b holds a second end of the tube 160 (either of which may be open, or be connected to a bag, fluid reservoir, cap, etc.). The two holders 130 are separated from one another via a cutting-clearance space 510, that is configured for a cutting-welding means 145 to move in to cut and weld the tube 160. In various embodiments, the cutting-clearance space 510 is dimensioned so that the portion of the tube 160 that is clamped between the first pinching surfaces 224a-b and the second pinching surfaces 352a-b remains at a smaller diameter than the nominal diameter of the tube 160 in an unclamped state.

In various embodiments, each frame 320a-b includes one or more respective position readers 520a-b (generally or collectively, position readers 520) and each selector wheel 310a-b includes a plurality of different position markers 530a-1, 530a-2, 530b-1, 530b-2 (generally or collectively, position markers 530. The present disclosure contemplates that more or fewer position readers 520 and position markers 530 may be included in various embodiments, with the position readers 520 and position markers 530 disposed at different locations and on different elements of the holders 130 than what is presented in the example illustrated in FIG. 5A.

In various embodiments, the position readers 520 and position markers 530 are in communication with a computer system used to control the tube-welding system 100 or the movement means, and act as an electrical interlock that prevents heating or raising the cutting-welding means 145 when a user has rotated the first selector wheel 310a to align pairs of divots 312 of a different size with the pinching surface 324a thereof than the second selector wheel 310b aligns with the pinching surface 324b thereof. In various embodiments, the position markers 530 may include electrical elements with different resistive, capacitive, inductive, etc. properties associated with each pair of divots 312 that complete a circuit in the position reader 520 so that a coded electrical signal is generated that uniquely corresponds to each position that the selector wheel 310 may be rotated to.

FIG. 5B illustrates a view 500b in which the holders 130 are pitched away from each other, so as to stretch a portion of the tube 160 captured between the respective pinching surfaces 324/352 of the two holders 130. Pitching the two holders 130 away from one another may increase a distance of the cutting-clearance space 510 towards the top of the holders 130, decrease the distance of the cutting-clearance space 510 towards the bottom of the holders 130, or both.

FIG. 5C illustrates a view 500c in which the holders 130 are pitched towards each other, so as to compress a portion of the tube 160 captured between the respective pinching surfaces 324/352 of the two holders 130. Pitching the two holders 130 towards each another may decrease the distance of the cutting-clearance space 510 towards the top of the holders 130, increase the distance of the cutting-clearance space 510 towards the bottom of the holders 130, or both.

Although FIGS. 5B and 5C illustrate both holders 130 being pitched in the same towards/away orientation, in various embodiments, only one holder 130 may be pitched at a time or both holders 130 may be pitched in the same forward/backward direction.

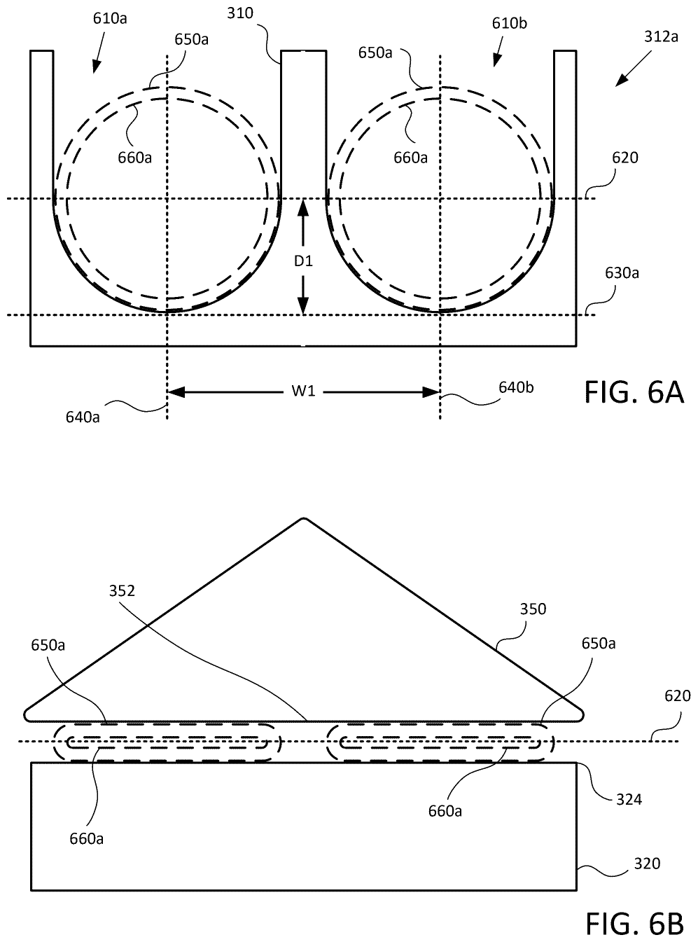

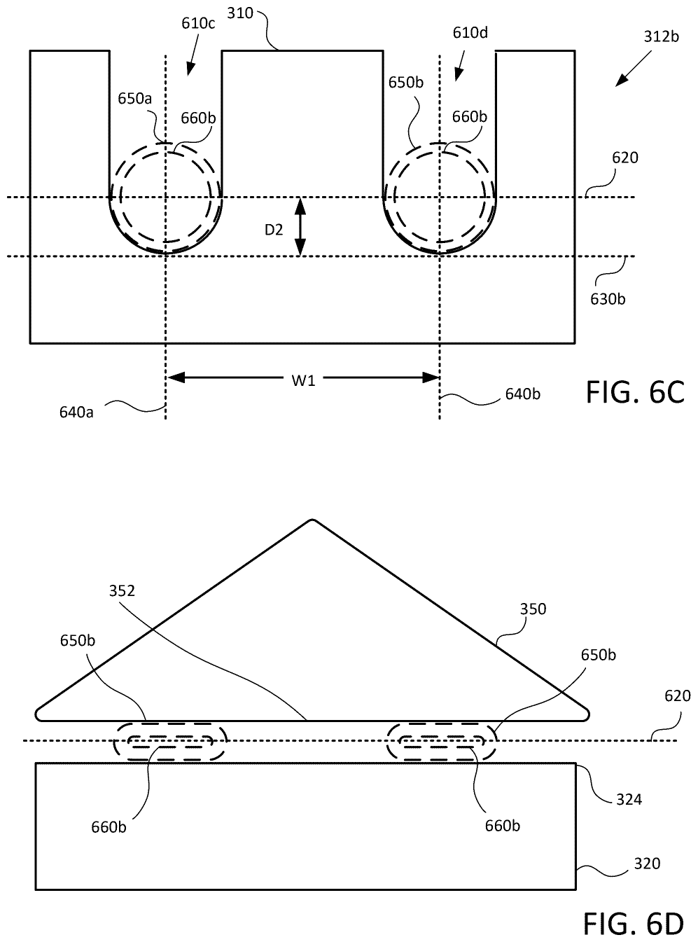

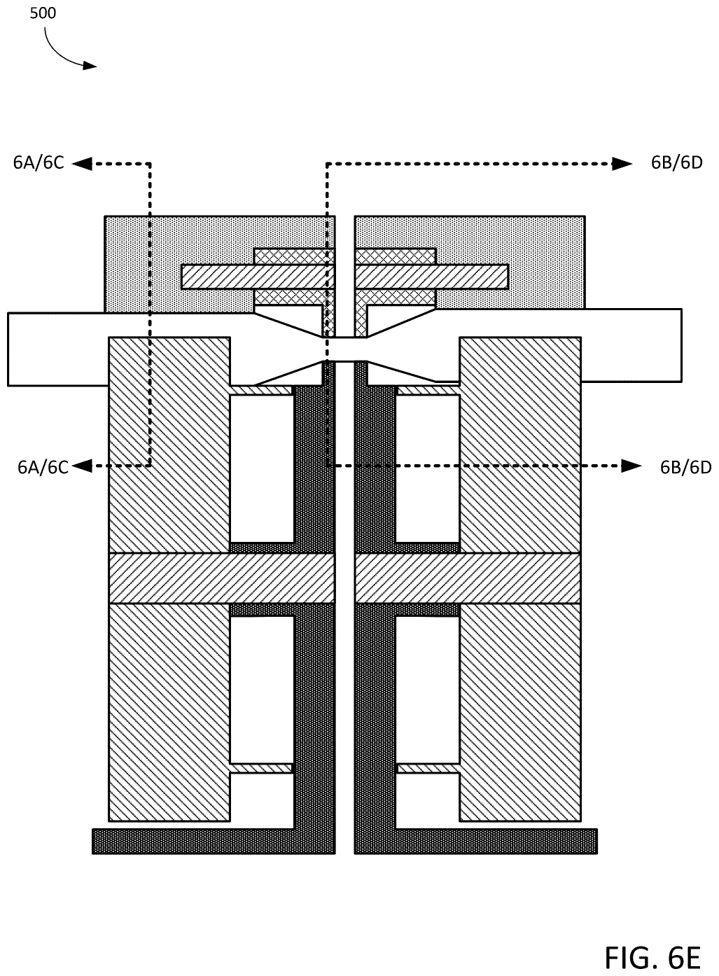

FIGS. 6A-6E illustrate spacing in the construction of tube-holding divots 610a-d (generally or collectively tube-holding divots 610) defined in the selector wheel 310 of an example holder 130, according to embodiments of the present disclosure. FIG. 6E demonstrates where the cross-sectional views shown in FIGS. 6A-6D are located relative to the view 500a shown in FIG. 5A. FIGS. 6A and 6B show a first pair of divots 312a, and FIGS. 6C and 6D show a second pair of divots 312b. The first pair of divots 312a includes a first divot 610a (generally or collectively, divot 610) and a second divot 610b, while the second pair of divots 312b includes a third divot 610c and a fourth divot 610d.

In various embodiments, the pairs of divots 610 may be configured to hold tubes with outer diameters of 5/32, 3/16, 7/32, 5/16, or ⅜ of an inch (approximately, 3.97, 4.76, 5.56, 7.94, and 9.53 mm respectively) although other outer diameters, specified using metric or French gauging standards may be used in defining the divots 610. In various embodiments, the selector wheel 310 may include one or more pairs of divots 312 with the same gauge as each other, but are configured to hold tubes 160 having different thicknesses between inner and outer diameters, or to hold identical tubes 160 (e.g., as a back-up or replacement pair 312).

In some embodiments, in a width direction, the centers of the individual divots 610 in each pair of divots 312 are located at a first width (W1) from each other. Accordingly, the mobile holder 130 can move the same distance in the width direction to align the tubes 160 during cutting/welding operations regardless of the size of the tubes 160.

In some embodiments, the centers of the individual divots 610 may be located at different widths from each other relative to other pairs 312, and the position sensors in the holders 130 may configure the movement means to align sections of the cut tubes 160 during the cutting/welding operations based on which pair 312 is aligned in a cutting/welding position (e.g., aligned with the pinching surface).

In a height direction, the centers of the individual divots 610 in each pair of divots are aligned to be above the pinching surface (when the selector wheel 310 is positioned to align the pair of divots 312 therewith) according to a thickness of the tube 160 (e.g., a distance between the outer diameter 650 and inner diameter 660 of a given tube 160). Accordingly, two tubes of a same thickness, even if having a first outer diameter 650a and first inner diameter 660a different from a second outer diameter 650b and a second inner diameter 660b would be aligned on the same plane 620 parallel to the pinching surface 324 of the frame 320. For example, the vertical distance between the pinching surface 324 and the plane 620 that the centers of the individual divots 610 are located in is approximately the thickness of the tube 160 configured to be placed in the individual divots 610.

Each divot 610 includes a straight portion, configured for easy insertion of a tube 160 into the divot 610, and a curved portion, adapted to fit the curvature of the outer diameter 650 of the tube 160t that the divot 610 is configured to hold. The nadir of the curved portion is located at a distance of the outer diameter 650 from the plane 620 that the center is disposed in. Depending on the outer diameter 650 that the divot 610 is configured to hold, the nadir may be located a different depths (D1, D2) from the central plane 620.

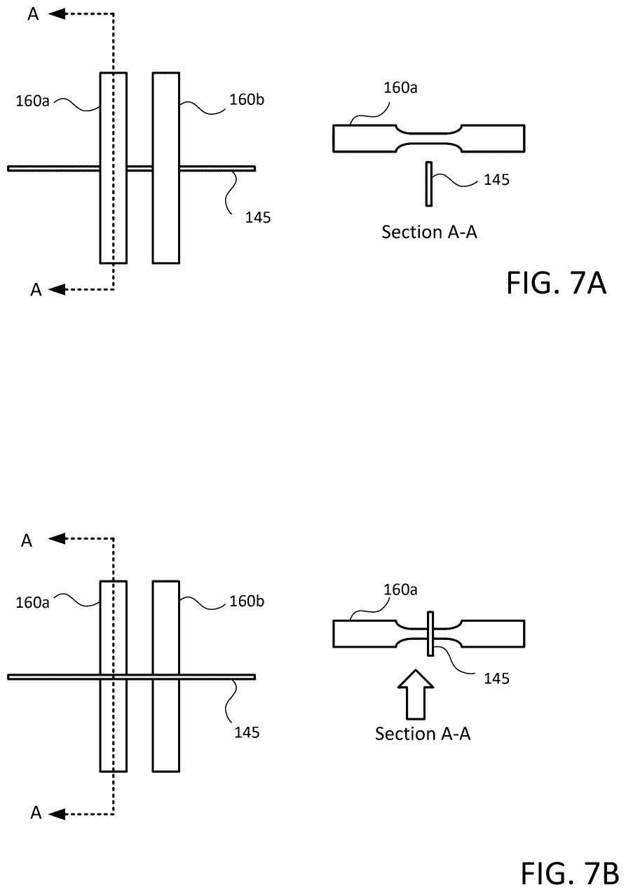

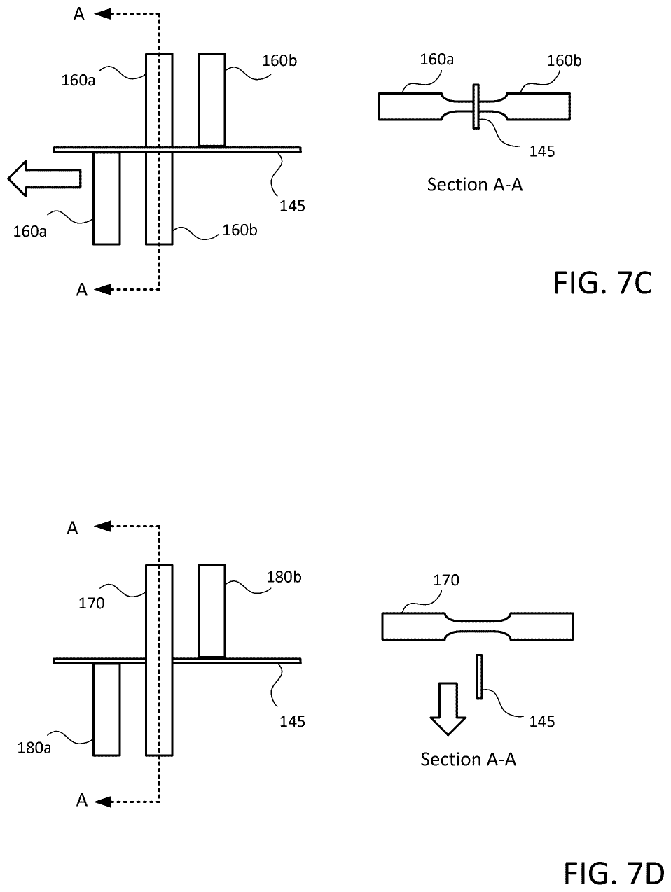

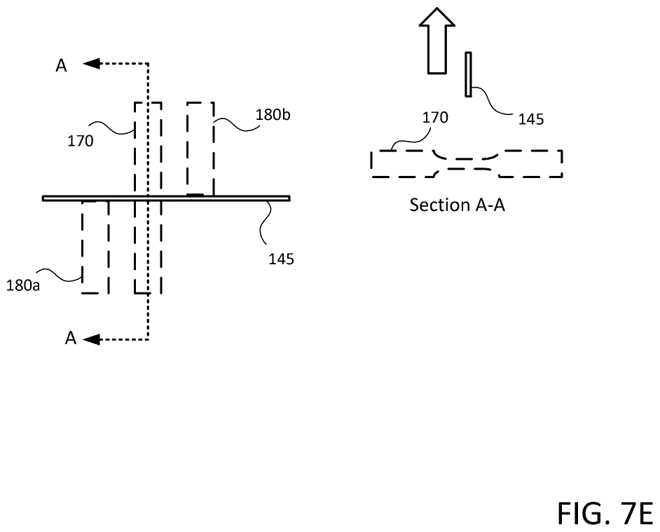

FIGS. 7A-7E illustrate the relative positions of various tubing 160 and the cutting-welding means 145 of the present disclosure during various operations for tube welding, according to embodiments of the present disclosure. In an initial position, shown in FIG. 7A, a first tube 160a and a second tube 160b are held in parallel, with the cutting-welding means 145 disposed beneath the tubes 160. Proceeding from the initial position to a second position, shown in FIG. 7B, the cutting-welding means 145 is raised to be between the tubes 160; cutting the first tube 160a and the second tube 160b each into two portions beneath the tubes 160, and remaining between the now-cut tubes 160. In some embodiments, when the cutting-welding means 145 is heated in the first position or the second position, the cutting-welding means 145 may remain in the second position for a predefined amount of time to transfer heat to the tubes 160 to partially melt the cut ends thereof.

Proceeding from the second position to a third position, shown in FIG. 7C, the cut ends of the tubes 160 are shifted (e.g., via a holder 130) such that one portion of the first tube 160a is aligned with one portion of the second tube 160b. If not previously heated, the cutting-welding means 145 is heated in the third position to partially melt the cut ends of the tubes 160.

Proceeding from the third position to a fourth position, shown in FIG. 7D, the cutting-welding means 145 is lowered back to the location seen in the first position from FIG. 7A, thereby allowing the melted ends of the tubes 160 to either melt to another tube, as the aligned portions of the first tube 160a and the second tube 160b define a joined tube 170, or to itself, as the un-aligned portions of the first tube 160a and the second tube 160b respectively form the first closed tube 180a and the second closed tube 180b.

In some embodiments, when the cutting-welding means 145 has reached an end of service, the system proceeds from the third position to a fifth position, shown in FIG. 7E, after an operator has removed the tubes from the system 100. The cutting-welding means 145 is raised to allow for replacement of the cassette 140 and prevent a subsequent cutting/welding operation until the cassette 140 is replaced, and a new cutting-welding means 145 is supplied. Additionally or alternatively to proceeding to the fifth position at the end of service of the cutting-welding means 145, the system 100 may activate a replacement indicator (e.g., an LED, a buzzer) and prevent the system from performing a subsequent cutting-welding operation until the cassette 140 is replaced (e.g., allowing for the removal of any tubing 160 before moving automatically or otherwise to a position above where the tubes 160 are located).

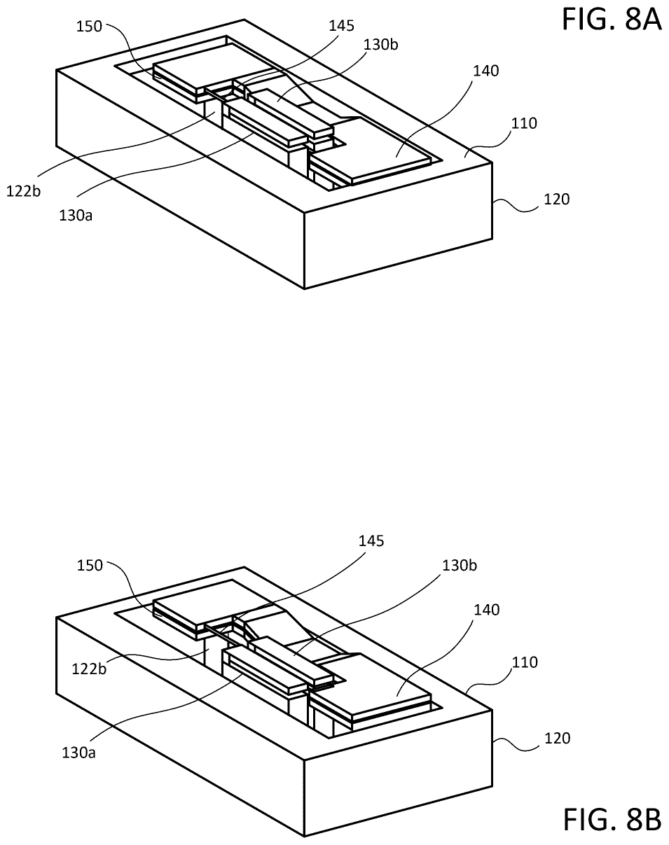

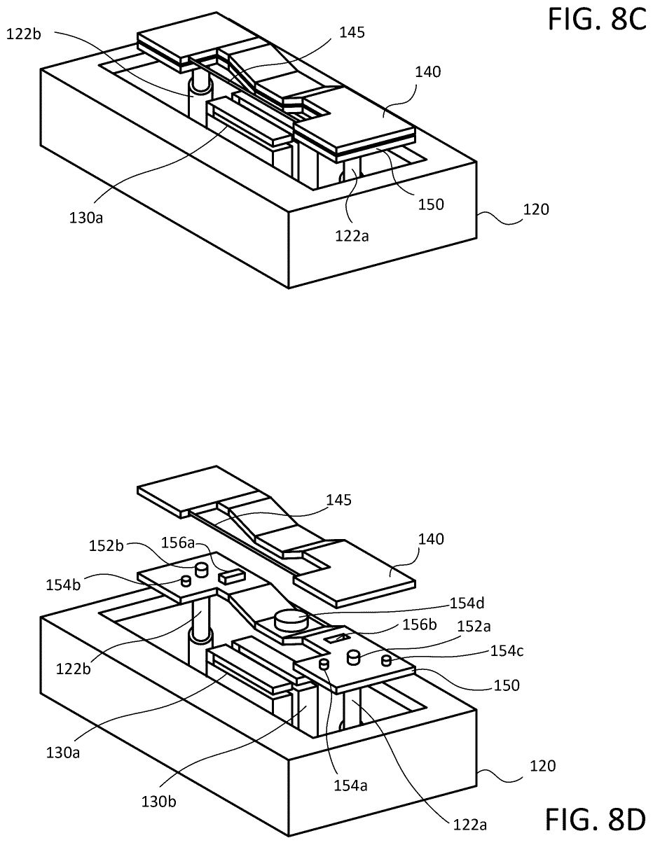

FIGS. 8A-8D illustrate various states of an example tube-welding system 100 with respect to a platform 150 and cassette 140, according to embodiments of the present disclosure.

FIG. 8A shows the system in a first state with the platform 150 and the cassette 140 positioned such that the cutting-welding means 145 is located below where the tubes 160 would be held by the holders 130 (see, FIG. 7A).

FIG. 8B shows the system in a second state with the platform 150 and the cassette 140 positioned such that the cutting-welding means 145 is located where the tubes 160 would be held by the holders 130 to cut and weld any tubes 160 so held (see, FIG. 7B).

FIG. 8C shows the system in a third state with the platform 150 and the cassette 140 positioned such that the cutting-welding means 145 is located above where the tubes 160 would be held by the holders 130 to allow for access to the cassette 140 (see, FIG. 7E).

FIG. 8D shows the system in a fourth state with the platform 150 in the same position as in the third state, but with the cassette 140 removed therefrom. In various embodiments, the platform 150 engages physical interlocks (e.g., latches and latch receivers) with the cassette 140 in the first position and the second position that are disengaged in the third position that otherwise hold the cassette 140 in place relative to the platform 150. Accordingly, at end of service or in response to a user command, the platform 150 presents the cassette 140 for easy removal and potential replacement by a new cassette 140 when in the third/fourth state, and reengages the physical interlocks (e.g., latches and latch receivers) when transitioned back to the first state or the second state.

In various embodiments, the platform is connected to one or more vertical movements means 122a-b that actuate to transition the platform 150 between the first and third states. The first through third states may be pre-defined stops in the vertical movement pattern of the platform 150 or may be configurable to include various states deeper or higher than the illustrated states that may be used for cutting tubes 160 of different sizes, securing the platform 150 deeper or higher into the case to permit the use of cutting-welding means 145 of different vertical sizes, to permit greater access to the interior of the case, etc.

As shown in FIG. 8D, the mating surfaces of the cassette 140 and the platform 150 are conformed to one another, and the upper surface of the platform 150 includes several devices that correspond to openings or connections defined in the bottom surface of the cassette 140. For example, one or more drive elements 152a-b (generally or collectively, drive elements 152) may be defined on the platform 150 to interact with spools in the cassette 140 to wind, unwind, and apply tension to the cutting-welding means 145. The drive elements 152 may include various capstans, pinions, or gears that are used to advance spools in the cassette to provide a new section of the cutting-welding means 145 for each set of tubes 160 to be cut and welded.

Similarly, various electrical elements 154a-d (generally or collectively, electrical elements 154) may be defined on the upper surface of the platform 150 to interface with electrical connections on the bottom surface of the cassette 140 (and power or communicate with any sensors, electrifying elements (e.g., for Joule-heating), or other devices therein) or to be inserted through holes in the bottom surface of the cassette 140 to insert various resistance sensors (e.g., resistance meaning means), electrifying elements, or the like into the body of the cassette 140. In some embodiments, the electrical elements 154 include a fan 154d, which may be inserted into the base of the cassette 140 to draw air and any smoke, fumes, or detritus produced during cutting or welding the tubes 160 into a filter assembly in the cassette 140.

Additionally, the platform 150 may include various interlocking or latching mechanisms 156a-b (generally or collectively, latching mechanisms 156) to secure the cassette 140 with the platform 150 during operation. For example, a first latching mechanism 156a may be provided that projects from the upper surface of the platform 150 into a corresponding cavity in the underside of the cassette 140 (e.g., a latch receiver) to engage therewith. In another example, a second latching mechanism 156b may be provided that projects inward from the upper surface of the platform 150 to receive a corresponding projection (e.g., a latch) on the underside of the cassette 140 to engage therewith.

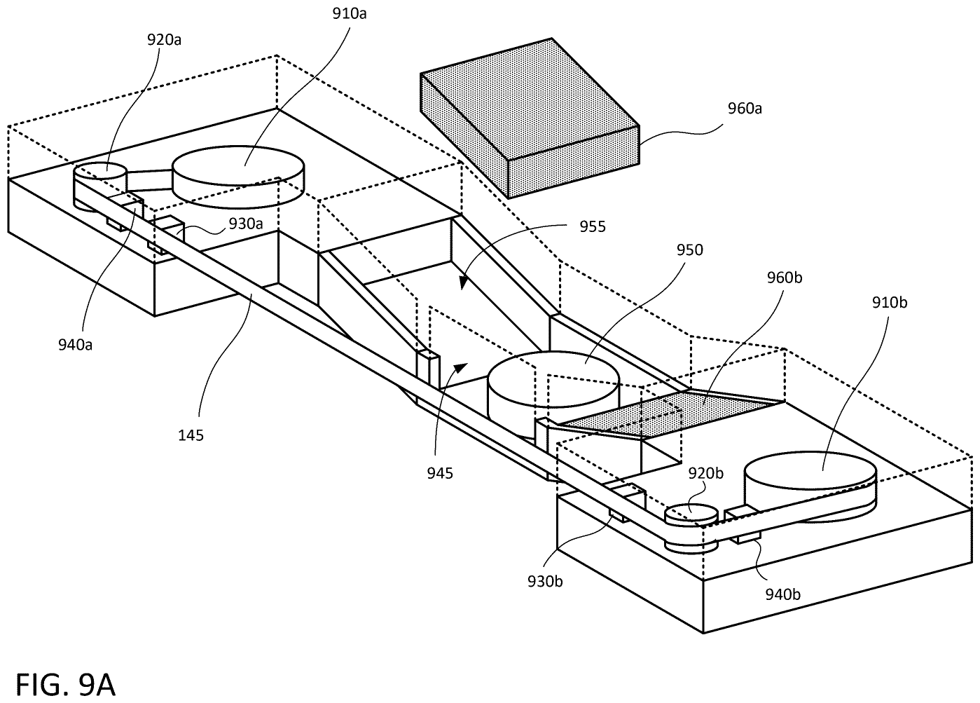

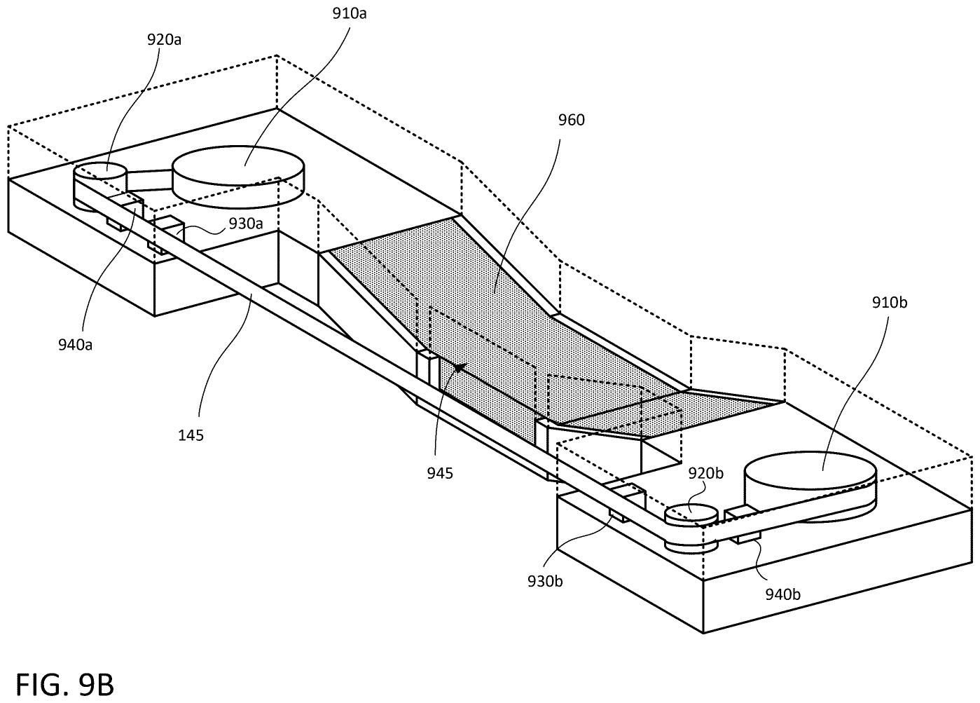

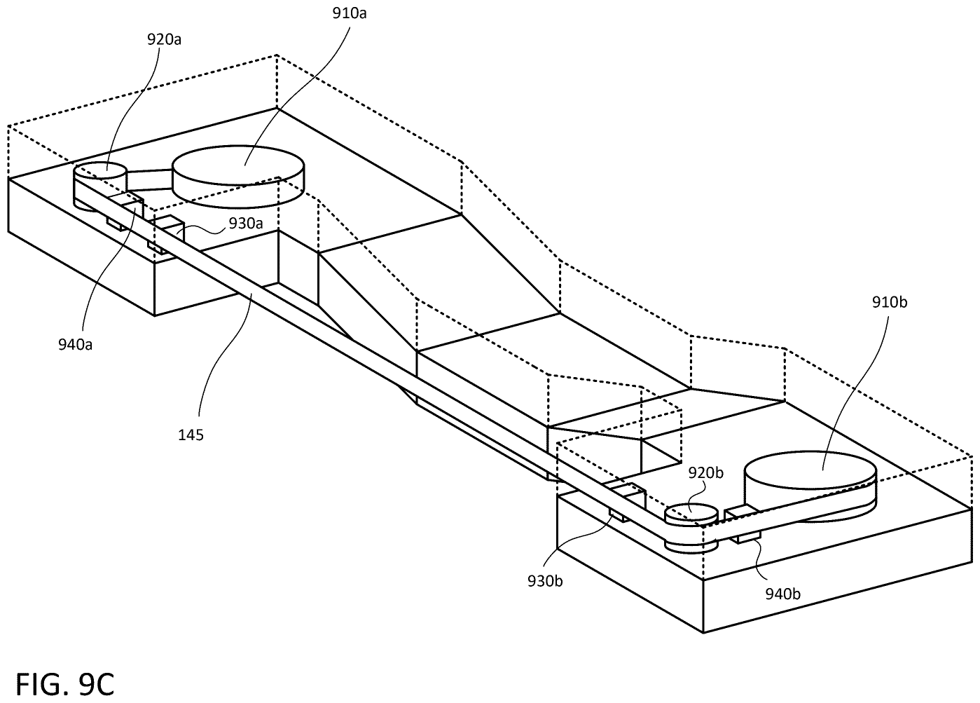

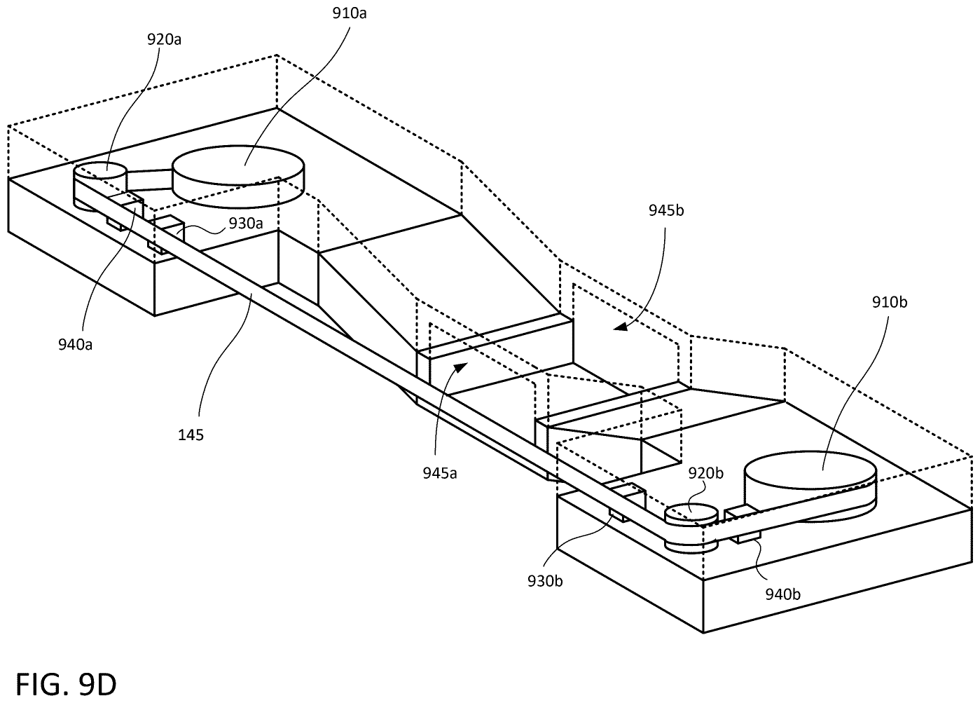

FIGS. 9A-9D illustrate various examples of cassettes 140 for use in an example tube-welding system, according to embodiments of the present disclosure.

Each of the example cassettes 140 includes a first spool 910a (generally or collectively, spool 910) and a second spool 910b secured in a housing 970, and between which the cutting-welding means 145 is held. The housing 970 is shaped such that the housing 970 exposes a middle segment of the cutting-welding means 145 disposed between the first spool 910a and the second spool 910b, leaving a first segment of the cutting-welding means 145 (disposed between the exposed middle segment and the first spool 910a) contained within the housing 970 and a second segment of the cutting-welding means 145 (disposed between the middle segment and the second spool 910b) contained within the housing 970.

In various embodiments, the cutting-welding means 145 is initially connected, on opposing ends, to the first spool 910a and the second spool 910b, and wound (for at least a majority of the length of the cutting-welding means 145) around the first spool 910a (e.g., as a supply spool). During operation, the cutting-welding means 145 is unwound from the first spool 910a and wound onto the second spool 910b (e.g., as an uptake spool) so that fresh sections of the cutting-welding means 145 are used for each cutting/welding operation, with the used sections being collected onto the second spool 910b. In various embodiments, the amount of cutting-welding means 145 initially wound onto the first spool 910a is sufficient for between 50 and 200 cutting/welding operations before the cassette reaches an end of service (e.g., when no further lengths of the cutting-welding means 145 can be wound off of the first spool 910a for presentation as the exposed middle portion). In various embodiments, the second spool 910b may be configured so that rotation is only permitted in the uptake direction so that any used section of the cutting-welding means 145 once wound onto the second spool 910b generally remains wound onto the second spool 910b unless an external actor releases the cutting-welding means 145. In various embodiments, the second spool 910b may retain the cutting-welding means 145 via a ratcheting mechanism, a friction hold, or the like.

By advancing fresh sections of cutting-welding means 145 for each cutting/welding operation and securing the used sections of the cutting-welding means 145, the present system reduces the generation of smoke and fumes that would otherwise result from depyrogenation of the electrifying elements, increases the sterility of the device, removes melted plastic from the cutting-welding means 145, improves coiling onto the second spool 910b, and reduces the risk of contamination, among other benefits.

In various embodiments, to aid in maintaining the tension of the cutting-welding means 145 between the two spools 910, various tensioning arms 920a-b on either side of the cassette 140 may be used to increase or decrease the tension on the cutting-welding means 145 disposed between the two spools 910. In various embodiments, the tensioning arms 910a-b may be included in the housing 970 as part of the cassette 140 or be included as part of the platform 150, and are inserted into the housing 970 to interact with the cutting-welding means 145. Additionally or alternatively, one or more of the spools 910 may be selectively controlled to rotate in a clockwise or counterclockwise direction to maintain a tension on the cutting-welding means 145 in a predefined window of force.

The electrifying elements use a four-wire design, which can include elements included in the cassette 140 as parts thereof or inserted into or around the housing 970 to interact with the cutting-welding means 145 from the platform 150. Voltage application terminals 940a-b are in contact with the cutting-welding means 145 and selectively impart a direct current (DC) voltage across the exposed middle section of the cutting-welding means 145 when engaged to heat the cutting-welding means 145. Because the temperature vs. resistance properties of the material used in the cutting-welding means 145 are known, temperature control can be accomplished without additional temperature measurement hardware and instead using resistance measuring probes 930a-b in contact with the heated portions of the cutting-welding means 145. In various embodiments, the resistance measuring probes 930a-b are incorporated into the tensioning arms 920a-b. The resistance measuring probes 930a-b are located outwardly relative to where the voltage application terminals 940a-b are located with respect to the cutting-welding means 145. The resistance sensors 930 measure a baseline resistance of the cutting-welding means 145 and monitor changes in resistance as the cutting-welding means 145 is heated to correlate the resistance for the material with a temperature of the material to thereby monitor how the cutting-welding means 145 is heated.

When advancing the cutting-welding means 145 after a cutting-welding operation (e.g., in preparation for a subsequent cutting-welding operation), the spools 910 advance the same length of the cutting-welding means 145 as is currently exposed to replace what is currently exposed. For example, of approximately 12 cm of the cutting-welding means is exposed from the cassette 140 between the voltage application terminals 940 at any given time, approximately 2 cm of which may be used for cutting and approximately 4 cm may come into contact with the tubing 160 (e.g., once the tubing 160 is shifted). However, the spools 910 will advance a fresh 12 cm not previously exposed to be between the voltage application terminals 940 for the next cutting-welding operation. By using a fresh section of cutting-welding means 145, any plastic residue from the tubes 160 melted onto the cutting-welding means may be shifted out of the heated portion of the cutting-welding means 145, which improves the ability to judge the heat of the cutting-welding means 145 by measuring the resistance thereof.

In various embodiments, the housing 970 defines a gull-winged shape, having the first spool 910a disposed on a first section and the second spool 910b disposed on a second section, wherein the first section and the second section are disposed in a first plane, and are linked via a central section disposed therebetween that dips below the first plane to allow space for the cassette 140 to raise and lower without touching, bending, or otherwise interfering with the tubes 160 being cut/welded except by the cutting-welding means 145. In some embodiments, the central section of the housing 970 defines a “V” shape, while in other embodiments, the central section of the housing 970 defines a spread-U shape (as in FIGS. 9A-9D), with a middle portion in a second plane parallel to the first plane and two linking sections that interest the first and second planes.

In various embodiments, the cassette 140 may include (or permit access from the platform 150) a fan 950, configured to pull air and any particulates (e.g., smoke, debris) from the cutting-welding operation into a space 955 defined in the housing 970 that includes one or more filters 960a-b (generally or collectively, filters 960). To permit the intake of air (or the outflow of air once the particulates are removed), one or more openings 945a-b (generally or collectively, openings 945) may be defined in the housing 970. For example, one or more intake openings 945 may be defined the surface facing the cutting-welding means 145 or the upper surface of the housing 970. Similarly, one or more outflow openings 945 may be defined the surface facing away from cutting-welding means 145 or the upper surface of the housing 970.

In some embodiments, the fan 950 may be omitted, or an external fan attached to an opening 945 to draw air through another opening 945 in the cassette 140. Similarly, in some embodiments one or more filters 960 may be included or omitted from the cassette 140.

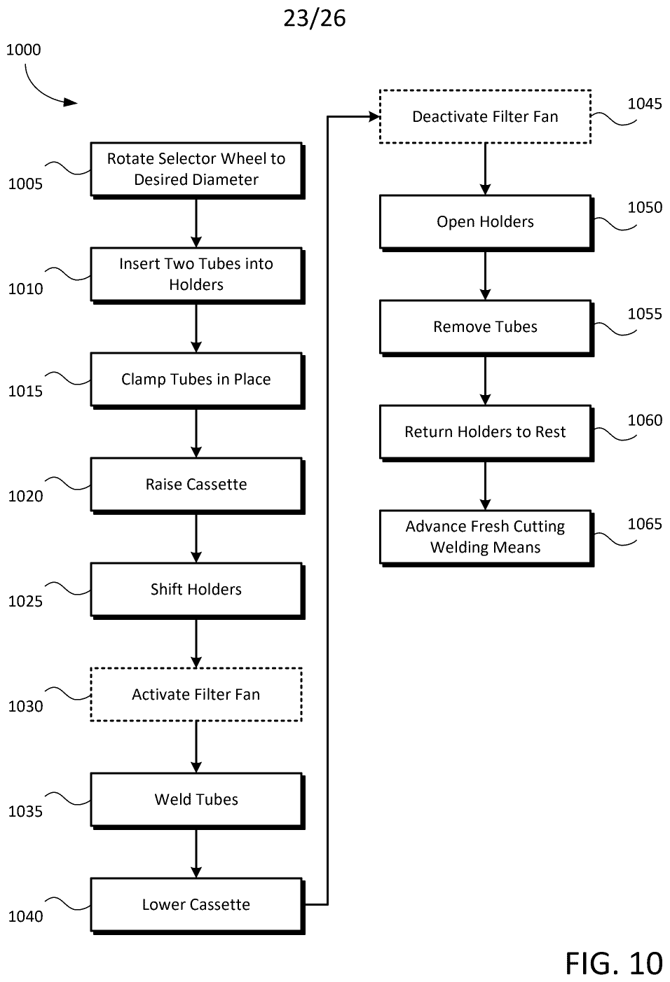

FIG. 10 is a flowchart of an example method 1000 of operation of a tube-welding system, according to embodiments of the present disclosure.

At block 1005, the system has the selector wheels of the holders rotated to present a desired gauge or diameter for the tubes to be cut and welded. In various embodiments, a human operator manually rotates the selector wheels, while in some embodiments, a drive motor rotates the selector wheels to an indicated state. In various embodiments, block 1005 may be omitted if the selector wheels are already in a desired position. In various embodiments, when the selector wheels of the system are not in the same state or are in a state in which a pair of divots are not positioned to interact with pinching surfaces (e.g., between two permissible states), the holders may electrically interlock the system from performing various cutting and welding operations.

At block 1010, an operator inserts two tubes to be joined into the divots in the selector wheel.

At block 1015, the operator clamps the tubes in the divots into place within the system. In various embodiments, the clamping is achieved between two pinching surfaces; one provided by a clamping bobbin in a clamp, and one provided in a frame of the selector wheel. The clamping prevents the outflow of any liquid in a reservoir or other system connected to the clamped tubing, and serves to hold the tubes in place for cutting/welding operations.

At block 1020, the system raises the cutting-welding means to intersect with the clamped tubing. In various embodiments, depending on the relative sizes of the cutting-welding means and the tubing, the cutting-welding means may be raised to fully or partially pass through the tubing in one or more passes, which may include side-to-side (e.g., sawing) motion to aid in cutting through the tubing.

At block 1025, the system shifts a mobile holder of the two holders in which the tubing is clamped. Because the divots are evenly spaced between the two holders, the system is able to move the mobile holder (e.g., in a left-to-right direction) by a predefined distance to align a cut portion of a first tube with a cut portion of a second tube. In various embodiments, block 1025 may be performed before or after block 1035 is performed. In various embodiments, the portions are aligned substantially coaxially, or may aligned according to the pitch of the holders so that respective ends meet.

At block 1030, the system optionally activates a filter fan, which may be part of a platform on which the cassette holding the cutting-welding means is secured, part of the cassette, or external to the system. Block 1030 may be performed any time before block 1035 is performed or while performing block 1035.

At block 1035, the system welds the tubes. In various embodiments, the tubes may be melted via direct heating via contact with the cutting-welding means when heated or via radiant heating from the cutting-welding means when separated from the cutting-welding means when heated. In various embodiments, the cutting-welding means is heated via resistive heating and the application of a DC voltage across an exposed section of the cutting-welding means, which may be heated before, during, or after the cutting operation. Additionally, the system may move the holders away from each other or towards each other (in a front-to-back directions, perpendicular to the left-to-right direction that the holders are shifted per block 1025 or pitching directions toward away from each other relative to the left-to-right direction) to improve the heating and joining of the tubes to each other rather than the to the cutting-welding means.

At block 1040, the system lowers the cutting-welding means back to a position out of contact with the tubes. At this time, the cut tubes are pressed together.

At block 1045, the system optionally deactivates the filtering fan (if activated per block 1030).

At block 1050, an operator opens the clamps of the holders, thereby unclamping the tubes that are now joined tubes.

At block 1055, an operator removes the now joined tube and the closed tubes formed from the tubes initially inserted into, cut, and welded by the system.

At block 1065, the system advances fresh cutting-welding means from the cassette and collects any used section of the cutting-welding means. In various embodiments, the fresh cutting-welding means is wound off of a first spool and the now-used section is wound onto a second spool within the cassette.

Method 1000 may then repeat from block 1005 for cutting and welding a subsequent pair of tubes, or proceed to method 1100 to replace a cassette if the end of service has been reached for the current cassette.

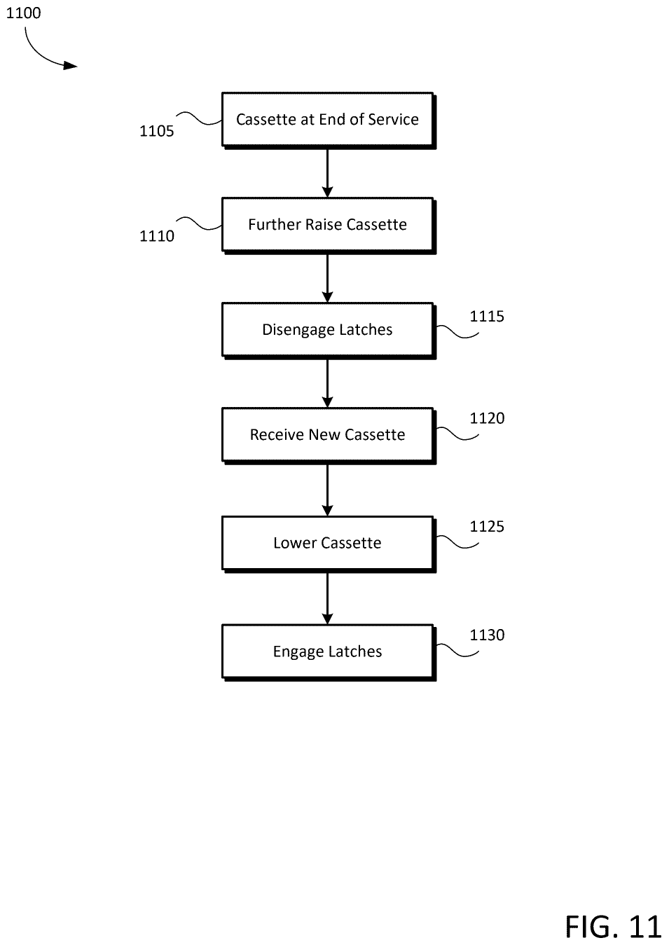

FIG. 11 is a flowchart of an example method 1100 of operation for replacing a cassette 140 for a tube-welding system 100, according to embodiments of the present disclosure. Method 1100 may be performed in response to a termination (and before a repetition) of method 1000.

At block 1105, the system identifies that the cassette has reached an end of service. In various embodiments, a cassette may reach end of service after performing a predefined number of cutting-welding operations, when a filter incorporated in the cassette is clogged, when a supply spool for the cutting-welding means is exhausted and can provide no more fresh sections of the cutting-welding means, etc.

At block 1110, the system further raises the cassette above where the cutting-welding would engage with any tubes inserted into the holders, and in some embodiments, raises the cassette above where the clamps are disposed.

At block 1115, the system automatically or an operator manually disengages the latches between the platform and the cassette determined to be at end of service. In various embodiments, block 1115 may be performed before, after, or simultaneously with block 1110.

At block 1120, an operator removes the cassette from the platform and provides a new cassette to the platform. In various embodiments, the operator may then dispose of the old cassette (e.g., recycle some or all of the cassette, treat some or all of the cassette as a biohazard, etc.).

At block 1125, the system lowers the platform and cassette to a ready position, with the cutting-welding means below where the next tubes to be cut and welded will be held by the holders.

At block 1130, the system automatically or an operator manually re-engages the latches between the platform and the cassette. In various embodiments, block 1130 may be performed before, after, or simultaneously with block 1125.

Method 1100 may then conclude, and the operator may again perform several iterations of method 1000 (discussed in relation to FIG. 10) with the new cassette until the new cassette also reaches an end of life, at which time method 1100 may be performed again.

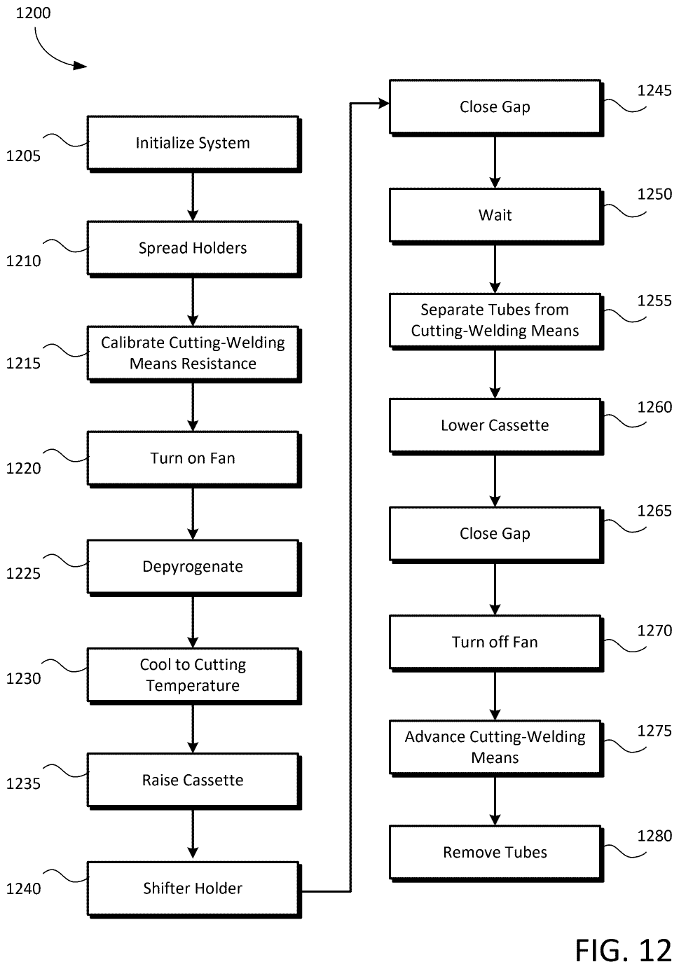

FIG. 12 is a flowchart of an example method 1200 of operation of a tube-welding system, according to embodiments of the present disclosure.

At block 1205, an operator initializes the system. As part of block 1205, the operator sets the selector wheels of the system to a desired location (or confirms that the desired location has been reached) to present the desired gauge of divots for holding the tubes to be cut. The cutting-welding means is held below the holding plane for where the tubes will be held by the selector wheels, and the operator inserts the pair of tubes to be cut and welded into the respective divots. At this time, the tubes are aligned parallel to one another, the cutting-welding means is below the cutting-welding temperature (e.g., room temperature of the ambient environment in which the system is located), and the cutting-welding means is held under tension. Once the tubes are inserted into the divots, the operator closes the clamps of the holders, securing the clamps via associated clasps to the frames and pinching the tubes between the pinching surfaces of the frames and clamping bobbins.

At block 1210, the system (optionally) spreads the holders apart to pre-stretch the tubes. In various embodiments, the spreading may be achieved by linearly moving one or more of the holders away from the other in a forward-backward direction or pitching one or more of the holders away from the other.

At block 1215, the system calibrates the resistance of the exposed section of the cutting-welding. The system electrically measures a baseline resistance for the given section of the cutting-welding means to calculate a target resistance to reach various target temperatures to depyrogenation, cutting, and welding.

At block 1220, the system turns on the fan (if included) to draw any smoke, fumes, or detritus produced during cutting or welding operation away from the cutting-welding means (e.g., into a filter).

At block 1225, the system depyrogenates the exposed section of the cutting-welding means by heating the exposed section via applied direct current to reach a calculated resistance associated with a temperature of approximately 400° C. for a first predefined length of time. The present disclosure contemplates that depyrogentation is a function of both temperature and time, and that one of skill in the art will be able to select different temperatures and different predefined times for how the system depryogenates the exposed section, which may be based on the material of the cutting-welding means, material used in the tubes being cut, coatings or films present on the cutting-welding means, environment in which the cutting-welding means is disposed, and cutting/welding profile used for the system.

At block 1230, the system permits the cutting-welding means to cool to a cutting temperature from the depyrogenation temperature. For example, depending on the material of the tubes to be cut, the system may wait for the cutting-welding means to cool to approximately 350° C., 325° C., 300° C., 275° C., 250° C., 225° C., etc., or another temperature above the melting temperature of the material of the tubes.

At block 1235, the system raises the cassette for the cutting-welding means to cut the tubes.

At block 1240, the system shifts the mobile holder to realign the cut ends of the tubes to be joined.

At block 1245, the system (optionally) partially closes the gap between the holders so that the tubes contact the cutting-welding means (having been pulled apart per block 1210 to induce tension to spring away from the cutting-welding means once cut per block 1240). In various embodiments, block 1245 may be omitted if block 1210 is omitted or block 1245 may be omitted if block 1210 is included and the operator wishes to melt the cut ends of the tubing via radiative transfer rather than direct transfer of heat. In various embodiments, if block 1210 was not performed prior to block 1240, block 1210 may be performed after block 1240 (and block 1245 omitted) if the operator wishes to melt the cut ends of the tubing via radiative transfer rather than direct transfer of heat.

At block 1250, the system waits a predefined amount of time or until signaled by the operator to permit the ends of the tubes to being to solidify.

At block 1255, the system separates the cut tube ends from the cutting-welding means.

At block 1260, the system lowers the cassette and the cutting-welding means out of contact (e.g., back to a rest position) with the tubing.

At block 1265, the system (optionally) partially closes the gap between the holders so that the cut ends of the tubes push into contact with one another.

At block 1270, the system turns off the fan.

At block 1275, the system advances a fresh section of the cutting-welding means. The system extensions the cutting-welding means, drives one or more of the spools to unwind a previously un-exposed section from a supply spool and take up the previously exposed section onto a take-up reel. In various embodiments, block 1275 may be performed as block 1280 is performed or the operator performs block 1205 for a subsequent performance of method 1200.

At block 1280, the operator removes the tubes from the tube holders. In various embodiments, the operator may discard or recycle the closed tubes (or store the closed tubes and any associated systems for later use) and may use the joined tube and any now-joined systems for various purposes.

Method 1200 may then repeat from block 1205 for cutting and welding a subsequent pair of tubes, or proceed to method 1100 to replace a cassette if the end of service has been reached for the current cassette.

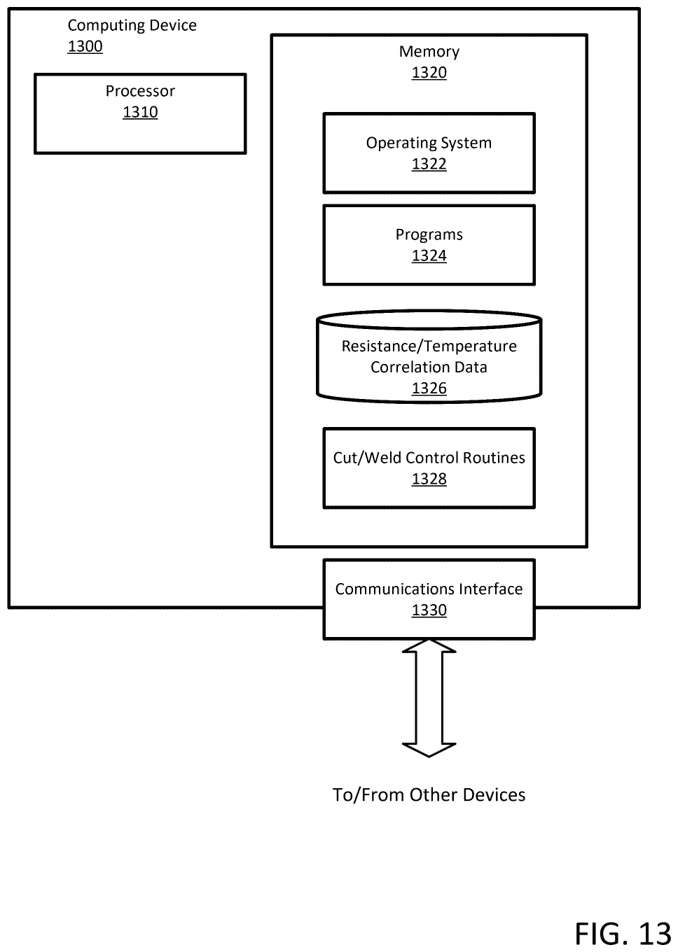

FIG. 13 illustrates a computing device 1300, as may be used to monitor, control, or aid in controlling a tube-welding system, according to embodiments of the present disclosure. The computing device 1300 may include at least one processor 1310, a memory 1320, and a communication interface 1330.

The processor 1310 may be any processing unit capable of performing the operations and procedures described in the present disclosure. In various embodiments, the processor 1310 can represent a single processor, multiple processors, a processor with multiple cores, and combinations thereof.

The memory 1320 is an apparatus that may be either volatile or non-volatile memory and may include RAM, flash, cache, disk drives, and other computer readable memory storage devices. Although shown as a single entity, the memory 1320 may be divided into different memory storage elements such as RAM and one or more hard disk drives. As used herein, the memory 1320 is an example of a device that includes computer-readable storage media, and is not to be interpreted as transmission media or signals per se.

As shown, the memory 1320 includes various instructions that are executable by the processor 1310 to provide an operating system 1322 to manage various features of the computing device 1300 and one or more programs 1324 to provide various functionalities to users of the computing device 1300, which include one or more of the features and functionalities described in the present disclosure. One of ordinary skill in the relevant art will recognize that different approaches can be taken in selecting or designing a program 1324 to perform the operations described herein, including choice of programming language, the operating system 1322 used by the computing device 1300, and the architecture of the processor 1310 and memory 1320. Accordingly, the person of ordinary skill in the relevant art will be able to select or design an appropriate program 1324 based on the details provided in the present disclosure.

In various embodiments, the memory 1320 stores data 1326 used for resistance/temperature correlations for various materials useful as cutting-welding means 145 to determine the temperature of an exposed section of the cutting-welding means 145 by measuring a resistance thereof associated with a given temperature. Additionally, the memory 1320 stores various cut/weld control routines 1328, among other programmatic data and instructions, to activate the various movement means, latches, drivers, and the like to perform some or all of the operations set forth in the methods 1000, 1100, 1200 described herein.

The communication interface 1330 facilitates communications between the computing device 1300 and other devices, which may also be computing devices as described in relation to FIG. 13. In various embodiments, the communication interface 1330 includes antennas for wireless communications and various wired communication ports. The computing device 1300 may also include or be in communication, via the communication interface 1330, one or more input devices (e.g., a keyboard, mouse, pen, touch input device, etc.) and one or more output devices (e.g., a display, speakers, a printer, etc.).

Although not explicitly shown in FIG. 13, it should be recognized that the computing device 1300 may be connected to one or more public and/or private networks via appropriate network connections via the communication interface 1330. It will also be recognized that software instructions may also be loaded into a non-transitory computer readable medium, such as the memory 1320, from an appropriate storage medium or via wired or wireless means.

Accordingly, the computing device 1300 is an example of a system that includes a processor 1310 and a memory 1320 that includes instructions that (when executed by the processor 1310) perform various embodiments of the present disclosure. Similarly, the memory 1320 is an apparatus that includes instructions that, when executed by a processor 1310, perform various embodiments of the present disclosure.

In addition to the embodiments described above, many examples of specific combinations are within the scope of the disclosure, some of which are detailed below:
Clause 1: An apparatus, comprising: a frame, defining a recess and a pinching surface; a selector wheel, disposed in the recess and defining a first pair of tube holding divots and a second pair of tube holding divots of a plurality of pairs of tube holding divots; and wherein: the selector wheel is rotatably connected to the frame, each divot of the first pair of tube holding divots is of a first gauge and each divot of the second pair of tube holding divots is of a second gauge, which different from the first gauge, the selector wheel is rotatable to a first position and a second position; in the first position, radial centers of the first pair of tube holding divots are aligned to be in a parallel plane to the pinching surface and radial centers of the second pair of tube holding divots are out of alignment with the pinching surface, and in the second position, the radial centers of the second pair of tube holding divots are aligned to be in the parallel plane with the pinching surface and the radial centers of the first pair of tube holding divots are out of alignment with the pinching surface.
Clause 2: The apparatus of any of clauses 1-6, further comprising: a linkage rotatably connected to a first side of the frame; a clamp rotatably connected on a first end to the linkage and selectively engageable on a second end with a second side of the frame; and a spring connected to the first end of the clamp and to the first side of the frame.
Clause 3: The apparatus of any of clauses 1-6, further comprising: a clamping bobbin defining a second pinching surface and; rotatably connected to the clamp.
Clause 4: The apparatus of any of clauses 1-6, further comprising: position sensors configured to uniquely identify which pair of the plurality of pairs of tube holding divots is rotated to be in alignment with the pinching surface.
Clause 5: The apparatus of any of clauses 1-6, wherein the radial centers of the first pair of tube holding divots are separated from each other by a first width and the radial centers of the second pair of tube holding divots are separated from each other by the first width.
Clause 6: The apparatus of any of clauses 1-6, wherein the radial centers of the first pair of tube holding divots are separated from respective bases of the first pair of tube holding divots by a first depth and the radial centers of the second pair of tube holding divots are separated from respective bases of the second pair of tube holding divots by a second depth, different from the first depth.
Clause 7: A tube-welding system, comprising: a first apparatus configured as a non-translating tube-holder; a second apparatus configured as a translating tube-holder, movable between a setup state, a cutting state, and a welding state, and separated from the first apparatus by a cutting-clearance space, wherein: each of the first apparatus and the second apparatus include: a frame, defining a recess and a pinching surface; a selector wheel, disposed in the recess and defining a first pair of tube holding divots and a second pair of tube holding divots of a plurality of pairs of tube holding divots; and wherein: the selector wheel is rotatably connected to the frame, each divot of the first pair of tube holding divots is of a first gauge and each divot of the second pair of tube holding divots is of a second gauge, which is different from the first gauge, the selector wheel is rotatable to a first position and a second position; in the first position, radial centers of the first pair of tube holding divots are aligned to be in a parallel plane to the pinching surface and radial centers of the second pair of tube holding divots are out of alignment with the pinching surface, and in the second position, the radial centers of the second pair of tube holding divots are aligned to be in the parallel plane with the pinching surface and the radial centers of the first pair of tube holding divots are out of alignment with the pinching surface, in the setup state and in the cutting state, a first tube holding divot of the first apparatus is aligned with a second tube holding divot of the second apparatus and a second tube holding divot of the first apparatus is aligned with a first tube holding divot of the second apparatus, and in the welding state, the first tube holding divot of the first apparatus is aligned with the first tube holding divot of the second apparatus.
Clause 8: The system of any of clauses 7-12, further comprising: a movement means connected to the second apparatus, configured to pitch the second apparatus towards or away from the first apparatus.
Clause 9: The system of any of clauses 7-12, further comprising: a movement means connected to the second apparatus, configured to move the second apparatus in a first direction and a second direction opposite to the first direction to transition the second apparatus between the cutting state and the welding state.
Clause 10: The system of any of clauses 7-12, wherein the movement means includes one of: a hydraulic piston; a pneumatic piston; a motor and lead screw assembly; a cam assembly; and a motor and track assembly.
Clause 11: The system of any of clauses 7-12, further comprising: a computer, configured to control the movement means in conjunction with a cutting-welding device disposed between the first apparatus and the second apparatus in the cutting-clearance space.
Clause 12: The system of any of clauses 7-12, wherein the computer is further configured to control the movement means to move the second apparatus by various distances based on a gauge of the two tubes being cut and welded.
Clause 13: An apparatus, comprising: a frame, defining a recess and a pinching surface; a paired tube holding means, configured to hold two tubes of a first gauge in alignment with the pinching surface when in a first state and to hold two tubes of a second gauge, different from the first gauge, in alignment with the pinching surface when in a second state; and wherein the paired tube holding means is rotatably connected to the frame to transition between the first state and the second state.
Clause 14: The apparatus of any of clauses 13-19, wherein the paired tube holding means defines a pair of tube holding divots on each side thereof.
Clause 15: The apparatus of any of clauses 13-19, further comprising: a linkage rotatably connected to a first side of the frame; a clamp rotatably connected on a first end to the linkage and selectively engageable on a second end with a second side of the frame; and a spring connected to the first end of the clamp and to the first side of the frame.
Clause 16: The apparatus of any of clauses 13-19, further comprising: a clamping bobbin defining a second pinching surface, rotatably connected to the clamp to align the second pinching surface parallel to the pinching surface.
Clause 17: The apparatus of any of clauses 13-19, further comprising: a position sensor configured to identify a rotational state of the paired tube holding means.
Clause 18: The apparatus of any of clauses 13-19, wherein the paired tube holding means is configured to position radial centers of every pair of tubes of a corresponding gauge by a first width from each other.
Clause 19: The apparatus of any of clauses 13-19, wherein the paired tube holding means is configured to position a first outer diameter of a first pair of tubes a first depth from the pinching surface when aligned with the pinching surface and to position a second outer diameter of a second pair of tubes a second depth from the pinching surface when aligned with the pinching surface, wherein the first depth and the second depth are different from each other and the first outer diameter and the second outer diameter are different from each other.
Clause 20: A tube-welding system, comprising: a first apparatus configured as a non-translating tube-holder; a second apparatus configured as a translating tube-holder, movable between a setup state, a cutting state, and a welding state and separated from the first apparatus by a cutting-clearance space, wherein: each of the first apparatus and the second apparatus include: a frame, defining a recess and a pinching surface; a paired tube holding means, configured to hold two tubes of a first gauge in alignment with the pinching surface when in a first state and to hold two tubes of a second gauge, different from the first gauge, in alignment with the pinching surface when in a second state; and wherein the paired tube holding means is rotatably connected to the frame to transition between the first state and the second state, in the setup state and the cutting state, a first tube holding divot of the first apparatus is aligned with a second tube holding divot of the second apparatus and a second tube holding divot of the first apparatus is aligned with a first tube holding divot of the second apparatus, and in the welding state, the first tube holding divot of the first apparatus is aligned with the first tube holding divot of the second apparatus.
Clause 21: The system of any of clauses 20-25, further comprising: a movement means connected to the second apparatus, configured to move the second apparatus in a first direction and a second direction opposite to the first direction to transition the second apparatus between the setup state and the cutting-welding state.
Clause 22: The system of any of clauses 20-25 further comprising: a movement means connected to the second apparatus, configured to pitch the second apparatus towards or away from the first apparatus.
Clause 23: The system of any of clauses 20-25 wherein the movement means includes one of: a hydraulic piston; a pneumatic piston; a motor and lead screw assembly; a cam assembly; and a motor and track assembly.
Clause 24: The system of any of clauses 20-25 further comprising: a computer, configured to control the movement means in conjunction with a cutting-welding device disposed between the first apparatus and the second apparatus in the cutting-clearance space.
Clause 25: The system of any of clauses 20-25, wherein the computer is further configured to control the movement means to move the second apparatus by various distances based on a gauge of the two tubes being cut and welded.

Certain terms are used throughout the description and claims to refer to particular features or components. As one skilled in the art will appreciate, different persons may refer to the same feature or component by different names. This document does not intend to distinguish between components or features that differ in name but not function.

As used herein, various chemical compounds are referred to by associated element abbreviations set by the International Union of Pure and Applied Chemistry (IUPAC), which one of ordinary skill in the relevant art will be familiar with. Similarly, various units of measure may be used herein, which are referred to by associated short forms as set by the International System of Units (SI), which one of ordinary skill in the relevant art will be familiar with.

As used herein, “about,” “approximately” and “substantially” are understood to refer to numbers in a range of the referenced number, for example the range of −10% to +10% of the referenced number, preferably −5% to +5% of the referenced number, more preferably −1% to +1% of the referenced number, most preferably −0.1% to +0.1% of the referenced number.

Furthermore, all numerical ranges herein should be understood to include all integers, whole numbers, or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

As used in the present disclosure, a phrase referring to “at least one of” a list of items refers to any set of those items, including sets with a single member, and every potential combination thereof. For example, when referencing “at least one of A, B, or C” or “at least one of A, B, and C”, the phrase is intended to cover the sets of: A, B, C, A-B, B-C, A-C, and A-B-C, where the sets may include one or multiple instances of a given member (e.g., A-A, A-A-A, A-A-B, A-A-B-B-C-C-C, etc.) and any ordering thereof. For avoidance of doubt, the phrase “at least one of A, B, and C” shall not be interpreted to mean “at least one of A, at least one of B, and at least one of C”.

As used in the present disclosure, the term “determining” encompasses a variety of actions that may include calculating, computing, processing, deriving, investigating, looking up (e.g., via a table, database, or other data structure), ascertaining, receiving (e.g., receiving information), accessing (e.g., accessing data in a memory), retrieving, resolving, selecting, choosing, establishing, and the like.

Without further elaboration, it is believed that one skilled in the art can use the preceding description to use the claimed inventions to their fullest extent. The examples and aspects disclosed herein are to be construed as merely illustrative and not a limitation of the scope of the present disclosure in any way. It will be apparent to those having skill in the art that changes may be made to the details of the above-described examples without departing from the underlying principles discussed. In other words, various modifications and improvements of the examples specifically disclosed in the description above are within the scope of the appended claims. For instance, any suitable combination of features of the various examples described is contemplated.

Within the claims, reference to an element in the singular is not intended to mean “one and only one” unless specifically stated as such, but rather as “one or more” or “at least one”. Unless specifically stated otherwise, the term “some” refers to one or more. No claim element is to be construed under the provision of 35 U.S.C. § 112(f) unless the element is expressly recited using the phrase “means for” or “step for”. All structural and functional equivalents to the elements of the various embodiments described in the present disclosure that are known or come later to be known to those of ordinary skill in the relevant art are expressly incorporated herein by reference and are intended to be encompassed by the claims. Moreover, nothing disclosed in the present disclosure is intended to be dedicated to the public regardless of whether such disclosure is explicitly recited in the claims.

1. An apparatus, comprising:
a frame, defining a recess and a pinching surface;
a selector wheel, disposed in the recess and defining a first pair of tube holding divots and a second pair of tube holding divots of a plurality of pairs of tube holding divots; and
wherein:
the selector wheel is rotatably connected to the frame,
each divot of the first pair of tube holding divots is of a first gauge and each divot of the second pair of tube holding divots is of a second gauge, which different from the first gauge,
the selector wheel is rotatable to a first position and a second position;
in the first position, radial centers of the first pair of tube holding divots are aligned to be in a parallel plane to the pinching surface and radial centers of the second pair of tube holding divots are out of alignment with the pinching surface, and
in the second position, the radial centers of the second pair of tube holding divots are aligned to be in the parallel plane with the pinching surface and the radial centers of the first pair of tube holding divots are out of alignment with the pinching surface.

2. The apparatus of claim 1, further comprising:
a linkage rotatably connected to a first side of the frame;
a clamp rotatably connected on a first end to the linkage and selectively engageable on a second end with a second side of the frame; and
a spring connected to the first end of the clamp and to the first side of the frame.

3. The apparatus of claim 2, further comprising:
a clamping bobbin defining a second pinching surface and; rotatably connected to the clamp.

4. The apparatus of claim 1, further comprising:
position sensors configured to uniquely identify which pair of the plurality of pairs of tube holding divots is rotated to be in alignment with the pinching surface.

5. The apparatus of claim 1, wherein the radial centers of the first pair of tube holding divots are separated from each other by a first width and the radial centers of the second pair of tube holding divots are separated from each other by the first width.

6. The apparatus of claim 1, wherein the radial centers of the first pair of tube holding divots are separated from respective bases of the first pair of tube holding divots by a first depth and the radial centers of the second pair of tube holding divots are separated from respective bases of the second pair of tube holding divots by a second depth, different from the first depth.

7. A tube-welding system, comprising:
a first apparatus configured as a non-translating tube-holder;
a second apparatus configured as a translating tube-holder, movable between a setup state, a cutting state, and a welding state, and separated from the first apparatus by a cutting-clearance space,
wherein:
each of the first apparatus and the second apparatus include:
a frame, defining a recess and a pinching surface;
a selector wheel, disposed in the recess and defining a first pair of tube holding divots and a second pair of tube holding divots of a plurality of pairs of tube holding divots; and
wherein:
the selector wheel is rotatably connected to the frame,
each divot of the first pair of tube holding divots is of a first gauge and each divot of the second pair of tube holding divots is of a second gauge, which is different from the first gauge,
the selector wheel is rotatable to a first position and a second position;
in the first position, radial centers of the first pair of tube holding divots are aligned to be in a parallel plane to the pinching surface and radial centers of the second pair of tube holding divots are out of alignment with the pinching surface, and
in the second position, the radial centers of the second pair of tube holding divots are aligned to be in the parallel plane with the pinching surface and the radial centers of the first pair of tube holding divots are out of alignment with the pinching surface,
in the setup state and in the cutting state, a first tube holding divot of the first apparatus is aligned with a second tube holding divot of the second apparatus and a second tube holding divot of the first apparatus is aligned with a first tube holding divot of the second apparatus, and
in the welding state, the first tube holding divot of the first apparatus is aligned with the first tube holding divot of the second apparatus.

8. The system of claim 7, further comprising:
a movement means connected to the second apparatus, configured to pitch the second apparatus towards or away from the first apparatus.

9. The system of claim 8, further comprising:
a computer, configured to control the movement means in conjunction with a cutting-welding device disposed between the first apparatus and the second apparatus in the cutting-clearance space and to control the movement means to move the second apparatus by various distances based on a gauge of the two tubes being cut and welded
wherein the movement means includes one of:
a hydraulic piston;
a pneumatic piston;
a motor and lead screw assembly;
a cam assembly; and
a motor and track assembly.

10. (canceled)

11. (canceled)

12. The system of claim 7, further comprising:
a movement means connected to the second apparatus, configured to move the second apparatus in a first direction and a second direction opposite to the first direction to transition the second apparatus between the cutting state and the welding state.

13. An apparatus, comprising:
a frame, defining a recess and a pinching surface;
a paired tube holding means, configured to hold two tubes of a first gauge in alignment with the pinching surface when in a first state and to hold two tubes of a second gauge, different from the first gauge, in alignment with the pinching surface when in a second state; and
wherein the paired tube holding means is rotatably connected to the frame to transition between the first state and the second state.

14. The apparatus of claim 13, wherein the paired tube holding means defines a pair of tube holding divots on each side thereof.

15. The apparatus of claim 13, further comprising:
a linkage rotatably connected to a first side of the frame;
a clamp rotatably connected on a first end to the linkage and selectively engageable on a second end with a second side of the frame; and
a spring connected to the first end of the clamp and to the first side of the frame.

16. The apparatus of claim 15, further comprising:
a clamping bobbin defining a second pinching surface, rotatably connected to the clamp to align the second pinching surface parallel to the pinching surface.

17. The apparatus of claim 13, further comprising:
a position sensor configured to identify a rotational state of the paired tube holding means.

18. The apparatus of claim 13, wherein the paired tube holding means is configured to position radial centers of every pair of tubes of a corresponding gauge by a first width from each other.

19. The apparatus of claim 13, wherein the paired tube holding means is configured to position a first outer diameter of a first pair of tubes a first depth from the pinching surface when aligned with the pinching surface and to position a second outer diameter of a second pair of tubes a second depth from the pinching surface when aligned with the pinching surface, wherein the first depth and the second depth are different from each other and the first outer diameter and the second outer diameter are different from each other.

20. A tube-welding system, comprising:
a first apparatus configured as a non-translating tube-holder;
a second apparatus configured as a translating tube-holder, movable between a setup state, a cutting state, and a welding state and separated from the first apparatus by a cutting-clearance space,
wherein:
each of the first apparatus and the second apparatus include:
a frame, defining a recess and a pinching surface;
a paired tube holding means, configured to hold two tubes of a first gauge in alignment with the pinching surface when in a first state and to hold two tubes of a second gauge, different from the first gauge, in alignment with the pinching surface when in a second state; and
wherein the paired tube holding means is rotatably connected to the frame to transition between the first state and the second state,
in the setup state and the cutting state, a first tube holding divot of the first apparatus is aligned with a second tube holding divot of the second apparatus and a second tube holding divot of the first apparatus is aligned with a first tube holding divot of the second apparatus, and
in the welding state, the first tube holding divot of the first apparatus is aligned with the first tube holding divot of the second apparatus.

21. The system of claim 20, further comprising:
a movement means connected to the second apparatus, configured to move the second apparatus in a first direction and a second direction opposite to the first direction to transition the second apparatus between the setup state and the cutting-welding state.

22. The system of claim 20, further comprising:
a movement means connected to the second apparatus, configured to pitch the second apparatus towards or away from the first apparatus.

23. (canceled)

24. The system of claim 22, further comprising:
a computer, configured to control the movement means in conjunction with a cutting-welding device disposed between the first apparatus and the second apparatus in the cutting-clearance space and to control the movement means to move the second apparatus by various distances based on a gauge of the two tubes being cut and welded.

25. (canceled)
